(19) United States
(12) Patent Application Publication
(10) Pub. No.: US 2026/0161056 A1
(43) Pub. Date: Jun. 11, 2026

(54) REFLECTION MODULE AND PERISCOPE CAMERA MODULE

(71) Applicant: NINGBO SUNNY OPOTECH CO., LTD, Zhejiang (CN)

(72) Inventors: Jingyuan JIN, Zhejiang (CN); Qi RONG, Zhejiang (CN); Feifan CHEN, Zhejiang (CN); Xue ZHANG, Zhejiang (CN)

(73) Assignee: NINGBO SUNNY OPOTECH CO., LTD, Zhejiang (CN)

(21) Appl. No.: 19/298,653

(22) Filed: Aug. 13, 2025

(30) Foreign Application Priority Data
Dec. 10, 2024 (CN) 202411813141.5

(51) Int. Cl. G03B 17/17; G03B 5/00

(52) U.S. Cl. CPC G03B 17/17; G03B 5/00; G03B 2205/0023

(57) ABSTRACT

The present application discloses a reflection module and a periscope camera module. The reflection module comprises: a reflection member for reflecting light incident from a first axis to a second axis, wherein the first axis intersects with the second axis; a rotation assembly for supporting the reflection member; a base having an internal space for accommodating rotation assembly; a rotation supporting part located between the bottom of the rotation assembly and the top of the base along a direction parallel to the first axis, wherein the rotation supporting part provides a rotation axis which passes through the rotation supporting part and is parallel to the second axis; and a rotation driving part for driving the rotation assembly and reflection members to rotate around the rotation axis. The rotation supporting part can carry the rotation assembly and drive the reflection member to rotate around the rotation axis, so that the image on the photosensitive surface of the photosensitive module generate an effect of rotating around the rotation axis, thereby compensating for the rotational and tilt jitter of the periscope camera module during usage.

### TECHNICAL FIELD

The present application relates to the field of optical imaging, and in particular to a reflection module and a periscope camera module.

### BACKGROUND ART

Camera modules are an indispensable part of mobile electronic devices. With the further development of camera module technology, users'demands for camera modules are becoming more and more sophisticated. The development of camera module products not only needs to meet the requirements of high performance such as background blur, night shooting, dual-camera zoom, etc., but also needs to meet the requirements of miniaturization, lightness, and compactness. In particular, the periscope camera module has a longer focal length based on the folded optical path through the optical path turning part and the lens part, which can meet the needs of high zoom and lightness at the same time, and has broad market prospects.

At present, the reflection module of the periscope camera module usually rotates around a rotation axis parallel to the incident light axis, and around a rotation axis perpendicular to the incident light axis and parallel to the imaging plane, which makes it difficult to correct image blur caused by rotational jitter.

### SUMMARY

One object of the present application is to provide a reflection module, which is conducive to correcting image blur caused by rotational jitter, thereby reducing aberration and improving imaging quality.

Another object of the present application is to provide a camera module having the above reflection module.

To achieve at least one of the above objects, the technical solution adopted by the present application is: a reflection module comprising: a reflection member for reflecting light incident from a first axis to a second axis, wherein the first axis intersects with the second axis; a rotation assembly for supporting the reflection member; a base having an internal space for accommodating the rotation assembly; a rotation supporting part located between the bottom of the rotation assembly and the top of the base along a direction parallel to the first axis, wherein the rotation supporting part provides a rotation axis which passes through the rotation supporting part and is parallel to the second axis; and a rotation driving part for driving the rotation assembly and the reflection member to rotate around the rotation axis.

Preferably, the rotation supporting part comprises at least two rotation supporting members spaced apart along a direction parallel to the second axis, the at least two rotation supporting members are crimped between the rotation assembly and the base, and the at least two rotation supporting members form a rotation axis, wherein the rotation axis and the second axis are parallel to each other but are not colinear.

Preferably, the reflection module further comprises a rotation retaining member and a pitch supporting part, and the rotation assembly, the rotation retaining member, the rotation supporting part and the base are stacked along a direction parallel to the first axis, so that the rotation supporting part is capable of supporting the rotation retaining member and the rotation assembly to perform rotational movement around the rotation axis relative to the base; the pitch supporting part is located between the rotation assembly and the rotation retaining member, and the pitch supporting part provides a pitch axis which is parallel to the third axis and is not colinear with the third axis, so that the rotation assembly is capable of performing pitching movement around the pitch axis relative to the rotation retaining member, wherein the third axis intersects with the first axis and the second axis.

Preferably, at least a part of the projection area of the rotation retaining member along the first axis overlaps with the projection area of the rotation assembly along the first axis, and at least a part of the projection area of the rotation retaining member along the second axis overlaps with the projection area of the rotation assembly along the second axis.

Preferably, the reflection module further comprises a pitch driving part, and the pitch driving part is located at the bottom of the rotation assembly, and the rotation driving part is located at the back of the rotation assembly, and the pitch driving part and the rotation driving part are arranged on different sides relative to the rotation assembly; the pitch driving part comprises at least one pitch magnet and at least one pitch coil, and the pitch magnet and the pitch coil are arranged opposite to each other along a direction parallel to the first axis, and are suitable for cooperating to drive the rotation assembly to perform pitching movement around the pitch axis relative to the rotation retaining member; the rotation driving part comprises at least one rotation magnet and at least one rotation coil, and the rotation magnet and the rotation coil are arranged opposite to each other along a direction parallel to the second axis, and are suitable for cooperating to drive the rotation assembly to rotate around the rotation axis relative to the base.

Preferably, the rotation magnet is curved in a plane perpendicular to the second axis, and the center of curvature of the rotation magnet is close to the second axis.

Preferably, the rotation supporting part comprises at least two supporting bosses, and the at least two supporting bosses protrude from one of the rotation retaining member and the base along a direction parallel to the first axis, and the at least two supporting bosses are crimped between the rotation retaining member and the base, and an imaginary line extending from the rotation axis passes through the at least two supporting bosses.

Preferably, the rotation supporting part comprises at least two supporting balls spaced apart along a direction parallel to the second axis, and the rotation retaining member is provided with at least two ball upper grooves, and the base is provided with at least two ball lower grooves, and the ball upper grooves and the ball lower grooves are arranged opposite to each other along a direction parallel to the first axis, and the at least two supporting balls are movably clamped between the ball upper grooves and the ball lower grooves, and an imaginary line extending from the rotation axis passes through the at least two supporting balls.

Preferably, the pitch supporting part comprises a pivot member which extends along a direction parallel to the third axis, and the pivot member enables the rotation assembly to be hinged to the rotation retaining member, so that the rotation assembly can perform a pitching movement around the pitch axis relative to the rotation retaining member.

Preferably, a projection of the pivot member along a direction parallel to the first axis falls between projections of the at least two rotation supporting members along a direction parallel to the first axis.

Preferably, among the at least two rotation supporting members, one of the rotation supporting members is arranged close to the reflection member along a direction parallel to the second axis, and the other rotation supporting member is arranged away from the reflection member along a direction parallel to the second axis, and the distance between the projection of the pivot member and the projection of the rotation supporting member away from the reflection member is L₁, and the distance between the projection of the pivot member and the projection of the rotation supporting member close to the reflection member is L₂, and L₁≤L₂.

Preferably, an imaginary line at which the projection of the pivot member along a direction parallel to the first axis is located and an imaginary line at which the projection of a line connecting the at least two rotation supporting members along a direction parallel to the first axis is located are perpendicular to each other.

Preferably, the reflection module further comprises a magnetic magnet and a magnetic yoke, the magnetic magnet is arranged at one of the rotation assembly and the base, and the magnetic yoke is arranged at the other of the rotation assembly and the base; a magnetic attraction force is generated between the magnetic magnet and the magnetic yoke along a direction parallel to the first axis, and under the action of the magnetic attraction force, the pitch supporting part is crimped between the rotation assembly and the rotation retaining member, and the rotation supporting part is crimped between the rotation retaining member and the base.

Preferably, the reflection module further comprises a sensing assembly which comprises at least one rotation sensing element and at least one pitch sensing element provided at the base, and the rotation sensing element and the rotation magnet are arranged opposite to each other along a direction parallel to the second axis, so that the rotation sensing element obtains the rotation magnetic field information of the rotation magnet, and the pitch sensing element and the pitch magnet are arranged opposite to each other along a direction parallel to the first axis, so that the pitch sensing element obtains the pitch magnetic field information of the pitch magnet.

Preferably, the magnetic poles of the rotation magnet are distributed along the bending direction of the rotation magnet, and under the condition that the rotation magnet rotates around the rotation axis relative to the rotation sensing element, along the second axis direction of OA2, the overlapping area between the magnetic poles of the rotation magnet and the rotation sensing element changes with the rotation angle of the rotation magnet.

Preferably, the rotation magnet comprises a first rotation magnet and a second rotation magnet spaced apart along a direction parallel to the third axis, the rotation sensing element comprises a first rotation sensing element and a second rotation sensing element, and the first rotation sensing element and the first rotation magnet are arranged opposite to each other along a direction parallel to the second axis, and the second rotation sensing element and the second rotation magnet are arranged opposite to each other along a direction parallel to the second axis, and the first rotation sensing element obtains first rotation magnetic field information of the first rotation magnet, and the second rotation sensing element obtains second rotation magnetic field information of the second rotation magnet, so that the stroke of the rotation assembly rotating around the rotation axis can be calculated by the first rotation magnetic field information and the second rotation magnetic field information.

Preferably, the pitch magnet comprises a first pitch magnet and a second pitch magnet spaced apart along a direction parallel to the third axis, and the pitch sensing element comprises a first pitch sensing element and a second pitch sensing element, and the first pitch sensing element and the first pitch magnet are arranged opposite to each other along a direction parallel to the first axis, and the second pitch sensing element and the second pitch magnet are arranged opposite to each other along a direction parallel to the first axis, and the first pitch sensing element obtains first pitch magnetic field information of the first pitch magnet, and the second pitch sensing element obtains second pitch magnetic field information of the second pitch magnet, so that the stroke of the rotation assembly rotating around the pitch axis can be calculated by the first pitch magnetic field information and the second pitch magnetic field information.

In order to achieve at least one of the above objects, the technical solution adopted by the present application is: a periscope camera module comprising: the reflection module mentioned above, wherein the reflection module is configured to reflect light incident from a first axis to a second axis, and the first axis intersects with the second axis; a lens module configured to receive the light from the reflection module and continue to propagate the light along a second axis; a photosensitive module configured to receive light and perform imaging; a base body having an accommodating cavity, wherein the reflection module and the lens module are arranged in the accommodating cavity, and the base of the reflection module are integrally or separately provided at the base body; and a shell which covers on the base body.

Compared with the prior art, the present application has the following beneficial effects:

The rotation supporting part supports the rotation retaining member and the rotation assembly, and drives the reflection member to rotate around the rotation axis, so that the image on the photosensitive surface of the photosensitive module produces the effect of rotating around the rotation axis, thereby compensating for the rotational jitter and tilt jitter of the periscope camera module during usage, and thus reducing the aberration and improving the imaging quality.

### BRIEF DESCRIPTION OF THE DRAWINGS

FIG. 1 is a schematic diagram of the three-dimensional structure of a periscope camera module according to some examples of the present application.

FIG. 2 is a schematic diagram of image plane compensation of a camera module according to the prior art.

FIG. 3 is a schematic diagram of image plane compensation of a periscope camera module according to some examples of the present application.

FIG. 4 is a cross-sectional view of a periscope camera module according to some examples of the present application.

FIG. 5 is an exploded view of a reflection module according to some examples of the present application.

FIG. 6 is a schematic diagram of a back three-dimensional structure of a reflection module according to some examples of the present application.

FIG. 7 is a schematic diagram of a bottom three-dimensional structure of a reflection module according to some examples of the present application.

FIG. 8 is a schematic diagram of a back three-dimensional structure of a rotation bracket according to some examples of the present application.

FIG. 9 is a schematic diagram of a front three-dimensional structure of a rotation bracket according to some examples of the present application.

FIG. 10 is a schematic diagram of a three-dimensional structure of a base according to some examples of the present application.

FIG. 11 is a schematic diagram of a three-dimensional structure of a rotation retaining member according to some examples of the present application.

FIG. 12 is a top view of a base according to some examples of the present application.

FIG. 13 is a schematic diagram of a three-dimensional structure of a rotation retaining member according to other examples of the present application.

FIG. 14 is a top view of a base according to some other examples of the present application.

FIG. 15 is a schematic diagram of forces acting on a rotation retaining member according to some examples of the present application.

FIG. 16 is a schematic diagram of a three-dimensional structure of a fixing bracket according to some examples of the present application.

FIG. 17 is a perspective schematic diagram of a second lens group installed on a lens carrier according to some examples of the present application.

In the figures: 1, reflection module; 11, reflection member; 111, reflection surface; 112, fixing surface; 12, first lens; 13, second lens; 20, rotation assembly; 21, bottom; 22, back; 23, side wall; 231, slot; 24, hollow area; 31, rotation bracket; 311, mounting surface; 32, fixing bracket; 321, first fixing part; 3211, first gap; 322, second fixing part; 3221, second gap; 40, rotation retaining member; 41, ball upper groove; 42, avoidance groove; 50, rotation supporting part; 51, rotation supporting member; 511, supporting boss; 512, supporting ball; 52, supporting groove; 60, pitch supporting part; 61, pivot member; 70, rotation driving part; 71, rotation magnet; 711, first magnetic region; 712, second magnetic region; 713, first rotation magnet; 714, second rotation magnet; 72, rotation coil; 721, first rotation coil; 722, second rotation coil; 80, pitch driving part; 81, pitch magnet; 811, third magnetic region; 812, fourth magnetic region; 813, first pitch magnet; 814, second pitch magnet; 82, pitch coil; 821, first pitch coil; 822, second pitch coil; 90, sensing assembly; 91, rotation sensing element; 911, first rotation sensing element; 912, second rotation sensing element; 92, pitch sensing element; 921, first pitch sensing element; 922, second pitch sensing element; 101, base; 1011, internal space; 1012, ball lower groove; 102, buffer part; 1021, first buffer member; 1022, second buffer member; 1023, third buffer member; 2, periscope camera module; 103, shell; 104, lens module; 1041, first lens group; 1042, second lens group; 105, lens carrier; 1051, guide groove; 1052, ball groove; 106, supporting member; 1061, guide rod; 1062, lens ball; 107, focus driving part; 108, photosensitive module; 109, base body; 1091, accommodating cavity.

### DETAILED DESCRIPTION

The present application is further described below in conjunction with particular implementation modes. It should be noted that, under the premise of no conflict, the various examples or technical features described below can be arbitrarily combined to form a new example.

In the description of the present application, it should be noted that directional words, such as the terms “center”, “lateral”, “longitudinal”, “length”, “width”, “thickness”, “up”, “down”, “front”, “back”, “left”, “right”, “vertical”, “horizontal”, “top”, “bottom”, “inside”, “outside”, “clockwise”, “counterclockwise”, etc., indicating directions and positional relationships are based on the directions or positional relationships shown in the accompanying drawings, and are only for the convenience of narrating the present application and simplifying the description, and do not indicate or imply that the device or element referred to must have a specific direction, be constructed and operated in a specific direction, and cannot be understood as limiting the specific scope of protection of the present application.

It should be noted that the terms “first”, “second”, etc. in the description and claims of the present application are used to distinguish similar objects, and are not necessarily used to describe a specific order or sequence.

The terms “including/comprising” and “having” and any variations thereof in the specification and claims of this application are intended to cover non-exclusive inclusions. For example, a process, method, system, product or apparatus comprising a series of steps or units is not necessarily limited to those steps or units explicitly listed, but may comprise other steps or units not explicitly listed or inherent to these processes, methods, products or apparatuses.

In the description of the present application, it is also necessary to explain that, unless otherwise clearly stipulated and limited, the terms “arrange”, “install”, “connect” and “connection” should be understood in a broad sense. For example, it can be a fixed connection, a detachable connection, or an integral connection; it can be a mechanical connection or an electrical connection; it can be a direct connection, a contacting connection, or an indirect connection through an intermediate medium; and it can be the internal connection of two elements. For those skilled in the art, the specific meanings of the above terms in the present application can be understood according to specific circumstances.

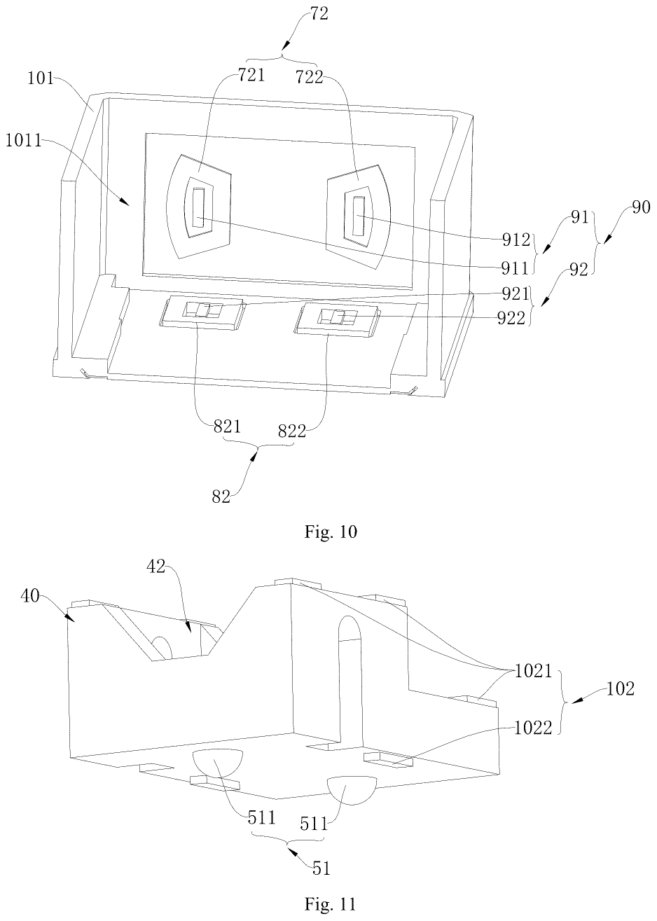

A reflection module 1, as shown in FIGS. 1-16, comprises: a reflection member 11, which is used for reflecting light incident along a first axis OA1 to a second axis OA2, wherein the first axis OA1 intersects with the second axis OA2; a rotation assembly 20, which is used for supporting the reflection member 11; a base 101, having an internal space 1011 for accommodating the rotation assembly 20; a rotation supporting part 50, which is located between the bottom 21 of the rotation assembly 20 and the top of the base 101 along a direction parallel to the first axis OA1, wherein the rotation supporting part 50 provides a rotation axis C1 which passes through the rotation supporting part 50 and is parallel to the second axis OA2; and a rotation driving part 70, which is used for driving the rotation assembly 20 and the reflection member 11 to rotate around the rotation axis C1.

It should be understood that the shaking of the periscope camera module 2 is an unexpected movement of the periscope camera module 2. For example, when an electronic device such as a mobile phone or a tablet is hand-held, the shaking or tilting of the hand is very likely to cause the shaking of the periscope camera module 2. In order to reduce the impact of unexpected movement on the final imaging of the periscope camera module 2, compensation is usually performed for up and down pitch and left and right swing. However, during the usage of the periscope camera module 2, the rotation and/or tilt or movement of the device may be caused by hand shaking of a user, which is mostly rotational jitter parallel to the imaging surface of the photosensitive chip of the photosensitive module 108. Therefore, compensation for rotational jitter is particularly important for the periscope camera module 2.

In the present application, the rotation assembly 20 is able to support the reflection member 11 and drive the reflection member 11 to rotate around the rotation axis C1 parallel to the second axis OA2, so that the image on the imaging surface of the photosensitive chip of the photosensitive module 108 produces an effect of rotating around an imaginary line parallel to the second axis OA2, thereby compensating for the rotational jitter and tilt jitter of the periscope camera module 2 during usage, and thus reducing the aberration and improving the imaging quality.

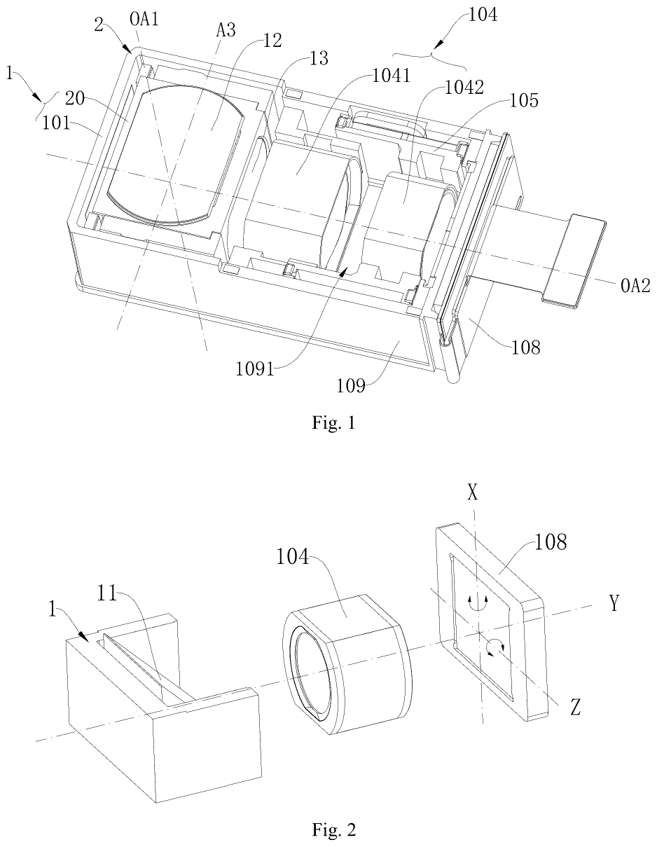

It should be understood that, as shown in FIG. 2, if the reflection member 11 is driven to swing around an imaginary line parallel to the first axis OA1, since the imaging surface of the photosensitive chip is located in a plane perpendicular to the second axis OA2, the image after the swinging motion of the reflection member 11 is projected onto the original plane perpendicular to the second axis OA2, and part of the imaging information will be lost. Furthermore, since the plane at which the aperture is located is also perpendicular to the plane of the second axis OA2, the swinging motion of the reflection member 11 will cause a part of the light originally involved in the imaging to be blocked, so that the MTF axis value of the reflection member 11 during the rotational movement around the rotation axis C1 is smaller than the MTF axis value when the object distance is infinite (INF state), that is, the swinging motion of the reflection member 11 around an imaginary line parallel to the first axis OA1 will cause the performance of the periscope camera module 2 to decrease, thereby affecting the final imaging quality.

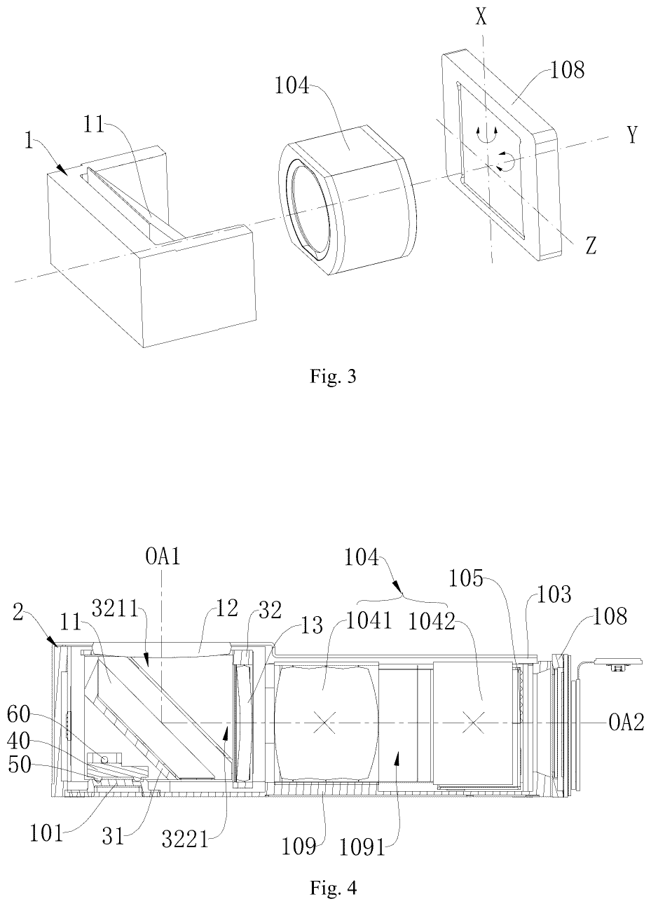

In the present application, as shown in FIG. 3, the rotational movement of the reflection member 11 around the rotation axis C1 can achieve compensation of the rotational direction. Particularly, since the imaging surface of the photosensitive chip is located in a plane perpendicular to the second axis OA2, and the plane at which the aperture is located is also a plane perpendicular to the second axis OA2, the image after the reflection member 11 rotates around the rotation axis C1 is projected onto the original plane perpendicular to the second axis OA2 and does not affect the size of the image. At the same time, it is beneficial for avoiding the loss of light participating in the imaging at the aperture, thereby making the MTF axis value of the reflection member 11 during the rotational movement around the rotation axis C1 consistent with or close to the MTF axis value when the object distance is infinite (INF state). That is to say, the rotational movement of the reflection member 11 around the rotation axis C1 only rotates the angle of the image on the imaging surface of the photosensitive chip, and there is no offset in the height position of the imaging surface, which is beneficial for avoiding affection of the MTF axis value of the periscope camera module 2. Particularly, MTF (Modulation Transfer Function) is a modulation transfer function, which can intuitively and accurately quantify the resolution capability of the periscope camera module 2.

It is worth mentioning that, because the diaphragm of the periscope camera module 2 is smaller, jitter will occur during night scene or video shooting, making the imaging effect relatively poor. The rotation assembly 20 supports the reflection member 11 to rotate around the rotation axis C1, which is beneficial for compensating for the rotation and jitter generated by the device in a dim environment and during video shooting, thereby improving the night scene shooting and video shooting performance of the periscope camera module 2.

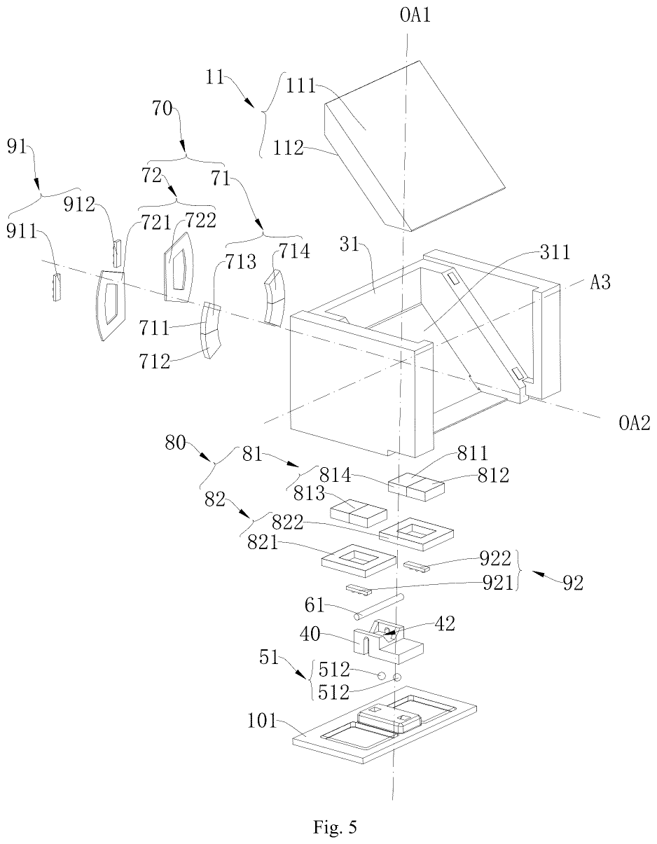

In some examples, as shown in FIGS. 4-7, the rotation supporting part 50 comprises at least two rotation supporting members 51 spaced apart along a direction parallel to the second axis OA2, and the at least two rotation supporting members 51 are crimped between the rotation assembly 20 and the base 101, and the at least two rotation supporting members 51 form a rotation axis C1, wherein the rotation axis C1 and the second axis OA2 are parallel to each other but are not colinear. That is to say, the rotation assembly 20 and the base 101 are respectively located on opposite sides of the rotation supporting member 51 along a direction parallel to the first axis OA1, and the rotation supporting member 51 is able to support the rotation assembly 20 so that the rotation assembly 20 and the base 101 are spaced apart along a direction parallel to the first axis OA1, which is beneficial for avoiding interference between the rotation assembly 20 and the base 101 during the rotational movement around the rotation axis C1.

It should be understood that, compared to the direct contact between the rotation assembly 20 and the base 101, in this example, the rotation supporting part 50 is crimped between the rotation assembly 20 and the base 101, so that the rotation supporting part 50 can support the rotation assembly 20 along a direction parallel to the first axis OA1, so as to reduce the contact area between the rotation assembly 20, the rotation supporting part 50 and the base 101, which is beneficial for reducing friction, so that the rotation assembly 20 can rotate more smoothly around the rotation axis C1, and is also conducive to reducing the power consumption required for the rotation assembly 20 to rotate.

In some examples, as shown in FIGS. 4-7, the reflection module 1 further comprises a rotation retaining member 40 and a pitch supporting part 60, and the rotation assembly 20, the rotation retaining member 40, the rotation supporting part 50 and the base 101 are stacked along a direction parallel to the first axis OA1. That is, the rotation supporting part 50 is crimped between the rotation retaining member 40 and the base 101, so as to support the rotation retaining member 40 and the rotation assembly 20 to rotate around the rotation axis C1 relative to the base 101. The pitch supporting part 60 is located between the rotation assembly 20 and the rotation retaining member 40. The pitch supporting part 60 provides a pitch axis C2, which passes through the rotation retaining member 40. The pitch axis C2 is parallel to the third axis A3 and is not colinear with the third axis A3. The rotation assembly 20 is able to perform a pitching movement around the pitch axis C2 relative to the rotation retaining member 40, wherein the third axis A3 intersects with the first axis OA1 and the second axis OA2.

It is worth mentioning that, the rotational movement of the rotation assembly 20 around the rotation axis C1 combined with the pitching movement of the rotation assembly 20 around the pitch axis C2 is conducive to making the jitter compensation of the periscope camera module 2 more omnidirectional, thereby better compensating for image blur caused by device rotation or hand shaking of a user.

Particularly, the rotation assembly 20 and the rotation retaining member 40 synchronously rotate around the rotation axis C1 relative to the base 101, so that the reflection member 11 rotates around the rotation axis C1, and then the imaging surface on the photosensitive chip rotates around the imaginary line extending along the rotation axis C1 to compensate for image blur caused by device rotation or hand shaking of a user. Furthermore, the rotation assembly 20 performs a pitching movement relative to the rotation retaining member 40 around the pitch axis C2, so that the reflection member 11 rotates around the pitch axis C2, and then the imaging surface on the photosensitive chip rotates around the imaginary line extending along the pitch axis C2, so as to further improve the anti-shake effect of the camera module, which is beneficial for reducing aberration and improve image quality.

In some examples, as shown in FIGS. 5-7, the reflection module 1 further comprises a pitch driving part 80 which is located at the bottom 21 of the rotation assembly 20, and the rotation driving part 70 is located at the back 22 of the rotation assembly 20. The pitch driving part 80 and the rotation driving part 70 are arranged on different sides relative to the rotation assembly 20, which is beneficial for avoiding interference in the magnetic field between the rotation driving part 70 and the pitch driving part 80, thereby improving the driving reliability of the reflection module 1. Particularly, the pitch driving part 80 comprises at least one pitch magnet 81 and at least one pitch coil 82, and the pitch magnet 81 and the pitch coil 82 are arranged opposite to each other along a direction parallel to the first axis OA1, and are suitable for cooperating with driving the rotation assembly 20 to perform pitching movement around the pitch axis C2 relative to the rotation retaining member 40; the rotation driving part 70 comprises at least one rotation magnet 71 and at least one rotation coil 72, and the rotation magnet 71 and the rotation coil 72 are arranged opposite to each other along a direction parallel to the second axis OA2, and are suitable for cooperating to drive the rotation assembly 20 to perform rotational movement around the rotation axis C1 relative to the base 101.

Furthermore, the reflection module 1 further comprises a driving circuit, which is electrically connected to the rotation coil 72 and the pitch coil 82 and provides current, so that the rotation coil 72 and the rotation magnet 71 cooperate with each other to drive the rotation assembly 20 to rotate around the rotation axis C1, and the pitch coil 82 and the pitch magnet 81 cooperate with each other to drive the rotation assembly 20 to pitch around the pitch axis C2. It is worth mentioning that, the driving circuit can be implemented as a conductive metal insert embedded in the base 101, or can be implemented as a flexible circuit board attached to the base 101, and the present application does not impose specific restrictions on this.

In some examples, as shown in FIG. 5, the rotation magnet 71 is curved in a plane perpendicular to the second axis OA2, and the center of curvature of the rotation magnet 71 is close to the second axis OA2. It should be understood that, compared to a long strip of magnet, the rotation magnet 71 in this example is implemented as a curved magnet with the center of curvature close to the second axis OA2, so that the magnetic lines of force can be more effectively concentrated, thereby generating a stronger magnetic field in a preset designated area, such as an area near the second axis OA2, or in an area near the rotation axis C1, so as to improve the stability and reliability of the acting force between the rotation magnet 71 and the rotation coil 72, thereby smoothly driving the rotation assembly 20 to rotate around the rotation axis C1. It is worth mentioning that, the curvature center of the rotation magnet 71 close to the second axis OA2 comprises: the curvature center of the rotation magnet 71 is located on the second axis OA2, and the curvature center of the rotation magnet 71 approaches the second axis OA2.

In at least one example, as shown in FIG. 5, the rotation magnet 71 comprises a first rotation magnet 713 and a second rotation magnet 714 spaced apart along a direction parallel to the third axis A3, wherein the curved shapes of the first rotation magnet 713 and the second rotation magnet 714 are both arc-shaped, and the center of the arc is located on the second axis OA2 or close to the second axis OA2, which is beneficial for enhancing the magnetic field strength between the rotation magnet 71 and the rotation coil 72, and improving the acting force between the rotation magnet 71 and the rotation coil 72.

In at least one example, the rotation magnet 71 adopts high-performance permanent magnet materials, including but not limited to: neodymium-iron-boron (Nd—Fe—B) permanent magnet materials, ferrite permanent magnet materials, etc., so that the rotation magnet 71 has a higher magnetic energy product and coercive force, so that the rotation magnet 71 can have a smaller volume while ensuring that the rotation magnet 71 has a stronger magnetic force, which is beneficial for increasing the driving force between the rotation magnet 71 and the rotation coil 72, and making the structure of the reflection module 1 more compact, which is beneficial for reducing the overall size of the reflection module 1.

In some examples, as shown in FIGS. 5-7, the rotation magnet 71 is provided at the back 22 of the rotation assembly 20, and the rotation magnet 71 comprises a first rotation magnet 713 and a second rotation magnet 714 spaced apart along a direction parallel to the third axis A3, and the first rotation magnet 713 and the second rotation magnet 714 both comprise a first magnetic region 711 and a second magnetic region 712 arranged along a bending direction, wherein the magnetic poles of the first magnetic region 711 and the second magnetic region 712 are oppositely arranged, and the magnetic poles of the first rotation magnet 713 and the second rotation magnet 714 are symmetrically arranged relative to the second axis OA2. For example, the first magnetic region 711 and the second magnetic region 712 of the first rotation magnet 713 are stacked along a direction of the first axis OA1, and the first magnetic region 711 and the second magnetic region 712 of the second rotation magnet 714 are stacked along a direction of the first axis OA1. Furthermore, the rotation coil 72 is provided at a side surface of the base 101 facing the back 22 of the rotation assembly 20, and the rotation coil 72 comprises a first rotation coil 721 and a second rotation coil 722. The first rotation coil 721 and the first rotation magnet 713 are arranged opposite to each other along a direction parallel to the second axis OA2, and the second rotation coil 722 and the second rotation magnet 714 are arranged opposite to each other along a direction parallel to the second axis OA2. Therefore, through the cooperation between the first rotation coil 721 and the first rotation magnet 713, and the cooperation between the second rotation coil 722 and the second rotation magnet 714, the rotation assembly 20 and the rotation retaining member 40 can be driven to rotate around the rotation axis C1 relative to the base 101 more reliably and smoothly. It is worth mentioning that, the rotation magnet 71 further comprises a neutral region located between the first magnetic region 711 and the second magnetic region 712.

It should be understood that, along a direction of the second axis OA2, when the rotation assembly 20 rotates around the rotation axis C1 from the initial state, if the overlapping area between the first magnetic region 711 of the first rotation magnet 713 and the first rotation coil 721 is decreased, and the overlapping area between the second magnetic region 712 of the first rotation magnet 713 and the first rotation coil 721 is increased; then the overlapping area between the first magnetic region 711 of the second rotation magnet 714 and the second rotation coil 722 is increased, and the overlapping area between the second magnetic region 712 of the second rotation magnet 714 and the second rotation coil 722 is decreased. On the contrary, if the overlapping area between the first magnetic region 711 of the first rotation magnet 713 and the first rotation coil 721 is increased, and the overlapping area between the second magnetic region 712 of the first rotation magnet 713 and the first rotation coil 721 is decreased; then the overlapping area between the first magnetic region 711 of the second rotation magnet 714 and the second rotation coil 722 is decreased, and the overlapping area between the second magnetic region 712 of the second rotation magnet 714 and the second rotation coil 722 is increased. That is to say, during the rotational movement of the rotation assembly 20 around the rotation axis C1, along a direction of the second axis OA2, the overlapping area between the first magnetic region 711 and the second magnetic region 712 of the rotation magnet 71 and the rotation coil 72 is variable. Furthermore, the changes of the overlapping area between the first magnetic region 711 of the rotation magnet 71 and the rotation coil 72 and the overlapping area between the second magnetic region 712 of the rotation magnet 71 and the rotation coil 72 are opposite to each other. Furthermore, the polarity of the magnetic pole of the first rotation magnet 713 having a larger overlapping area with the first rotation coil 721 and the polarity of the magnetic pole of the second rotation magnet 714 having a larger overlapping area with the second rotation coil 722 are opposite. Particularly, the initial state is the state before the reflection module 1 is driven.

In some examples, the rotation magnet 71 is a bipolar magnet, which is helpful to reduce the difficulty of manufacturing the rotation magnet 71, thereby reducing the manufacturing cost of the rotation magnet 71. For example, the first magnetic region 711 of the rotation magnet 71 is implemented as an N pole, and the second magnetic region 712 is implemented as an S pole. For another example, the first magnetic region 711 of the rotation magnet 71 is implemented as an S pole, and the second magnetic region 712 is implemented as an N pole. This application does not impose any specific limitation on this. The N pole and the S pole are overlapped along a direction of the first axis OA1.

In some other examples, the rotation magnet 71 is a multi-pole magnet, which is beneficial for improving the magnetic field strength of the rotation magnet 71 and improving the reliability and stability of the cooperation between the rotation magnet 71 and the rotation coil 72. For example, the side of the first magnetic region 711 close to the rotation coil 72 is implemented as an N pole, and the side of the first magnetic region 711 away from the rotation coil 72 is implemented as an S pole; the side of the second magnetic region 712 close to the rotation coil 72 is implemented as an S pole, and the side of the second magnetic region 712 away from the rotation coil 72 is implemented as an N pole. For another example, the side of the first magnetic region 711 close to the rotation coil 72 is implemented as an S pole, and the side of the first magnetic region 711 away from the rotation coil 72 is implemented as an N pole; the side of the second magnetic region 712 close to the rotation coil 72 is implemented as an N pole, and the side of the second magnetic region 712 away from the rotation coil 72 is implemented as an S pole. This application does not impose any specific limitation on this. The N pole and the S pole are overlapped along a direction of the first axis OA1 and along a direction of the second axis OA2.

In some examples, as shown in FIGS. 5-7, the rotation coil 72 is winded in a fan shape to be adapted to the above curved rotation magnet 71, which is beneficial for increasing the relative area between the rotation coil 72 and the rotation magnet 71, and thus is beneficial for enhancing the magnetic field, increase the magnetic flux, and reduce the magnetic loss. The rotation coil 72 and the rotation magnet 71 are able to provide a greater driving force to the rotation assembly 20, which is beneficial for making the rotation assembly 20 to rotate around the rotation axis C1 more reliably and stably.

In some examples, as shown in FIGS. 5-7, the pitch magnet 81 is provided at the bottom 21 of the rotation assembly 20, and the pitch magnet 81 comprises a first pitch magnet 813 and a second pitch magnet 814 spaced apart along a direction parallel to the third axis A3, and the first pitch magnet 813 and the second pitch magnet 814 both comprise a third magnetic region 811 and a fourth magnetic region 812 arranged along a direction parallel to the second axis OA2, wherein the magnetic poles of the third magnetic region 811 and the fourth magnetic region 812 are oppositely arranged, and the magnetic poles of the first pitch magnet 813 and the second pitch magnet 814 are symmetrically arranged relative to the second axis OA2. For example, the third magnetic region 811 and the fourth magnetic region 812 of the first pitch magnet 813 are stacked along a direction of the second axis OA2, and the third magnetic region 811 and the fourth magnetic region 812 of the second pitch magnet 814 are stacked along a direction of the second axis OA2. Furthermore, the pitch coil 82 is arranged on a side surface of the base 101 facing the bottom 21 of the rotation assembly 20, and the pitch coil 82 comprises a first pitch coil 821 and a second pitch coil 822. The first pitch coil 821 and the first pitch magnet 813 are arranged opposite to each other along a direction parallel to the first axis OA1, and the second pitch coil 822 and the second pitch magnet 814 are arranged opposite to each other along a direction parallel to the first axis OA1. Therefore, through the cooperation between the first pitch coil 821 and the first pitch magnet 813, and the cooperation between the second pitch coil 822 and the second pitch magnet 814, the rotation assembly 20 can be driven to pitch around the pitch axis C2 relative to the base 101 more reliably and smoothly. It is worth mentioning that, the pitch magnet 81 further comprises a neutral region located between the third magnetic region 811 and the fourth magnetic region 812.

It should be understood that, along a direction of the third axis A3, when the rotation assembly 20 performs pitching movement around the pitch axis C2, the distance between the third magnetic region 811 of the first pitch magnet 813 and the first pitch coil 821 along a direction parallel to the first axis OA1 is decreased, and the distance between the fourth magnetic region 812 of the first pitch magnet 813 and the first pitch coil 821 along a direction parallel to the first axis OA1 is increased; at the same time, the distance between the third magnetic region 811 of the second pitch magnet 814 and the second pitch coil 822 along a direction parallel to the first axis OA1 is also decreased, and the distance between the fourth magnetic region 812 of the second pitch magnet 814 and the second pitch coil 822 along a direction parallel to the first axis OA1 is also increased. On the contrary, the distance between the third magnetic region 811 of the first pitch magnet 813 and the first pitch coil 821 along a direction parallel to the first axis OA1 is increased, and the distance between the fourth magnetic region 812 of the first pitch magnet 813 and the first pitch coil 821 along a direction parallel to the first axis OA1 is decreased; at the same time, the distance between the third magnetic region 811 of the second pitch magnet 814 and the second pitch coil 822 along a direction parallel to the first axis OA1 is also increased, and the distance between the fourth magnetic region 812 of the second pitch magnet 814 and the second pitch coil 822 along a direction parallel to the first axis OA1 is also decreased. That is to say, during the pitching movement of the rotation assembly 20 around the pitch axis C2, along a direction of the third axis A3, the distance between the third magnetic region 811 and the fourth magnetic region 812 of the pitch magnet 81 and the pitch coil 82 can be changed. Furthermore, the changes of the distance between the third magnetic region 811 of the pitch magnet 81 and the pitch coil 82 and the distance between the fourth magnetic region 812 of the pitch magnet 81 and the pitch coil 82 are opposite.

In some examples, the pitch magnet 81 is a bipolar magnet, which is helpful to reduce the manufacturing difficulty of the pitch magnet 81, thereby reducing the manufacturing cost of the pitch magnet 81. For example, the third magnetic region 811 of the pitch magnet 81 is implemented as an N pole, and the fourth magnetic region 812 is implemented as an S pole. For another example, the third magnetic region 811 of the pitch magnet 81 is implemented as an S pole, and the fourth magnetic region 812 is implemented as an N pole. This application does not impose any specific limitation on this. The N pole and the S pole are overlapped along a direction of the second axis OA2.

In some other examples, the pitch magnet 81 is a multi-pole magnet, which is beneficial for improving the magnetic field strength of the pitch magnet 81 and improving the reliability and stability of the coordination between the pitch magnet 81 and the pitch coil 82. For example, the side of the third magnetic region 811 close to the pitch coil 82 is implemented as an N pole, and the side of the third magnetic region 811 away from the pitch coil 82 is implemented as an S pole; the side of the fourth magnetic region 812 close to the pitch coil 82 is implemented as an S pole, and the side of the fourth magnetic region 812 away from the pitch coil 82 is implemented as an N pole. For another example, the side of the third magnetic region 811 close to the pitch coil 82 is implemented as an S pole, and the side of the third magnetic region 811 away from the pitch coil 82 is implemented as an N pole; the side of the fourth magnetic region 812 close to the pitch coil 82 is implemented as an N pole, and the side of the fourth magnetic region 812 away from the pitch coil 82 is implemented as an S pole. This application does not impose any specific limitation on this. Particularly, the N pole and the S pole are overlapped along a direction of the first axis OA1 and along a direction of the second axis OA2.

In some examples, as shown in FIG. 5, the pitch magnet 81 is implemented as a bar magnet, which is helpful to simplify the design of the pitch magnet 81, reduce the manufacturing difficulty, and further help reduce the production cost of the pitch magnet 81. In addition, the bar-shaped pitch magnet 81 can provide a relatively uniform magnetic field, thereby facilitating improving the response speed and control accuracy of the reflection module 1.

It is worth mentioning that, when the rotation assembly 20 only rotates around the rotation axis C1, the distance between the rotation magnet 71 and the rotation coil 72 along a direction parallel to the second axis OA2 remains unchanged, which is beneficial for improving the stability of the acting force between the rotation magnet 71 and the rotation coil 72. When the rotation assembly 20 only has a pitching movement around the pitch axis C2, the distance between the pitch magnet 81 and the pitch coil 82 can be changed, as described above.

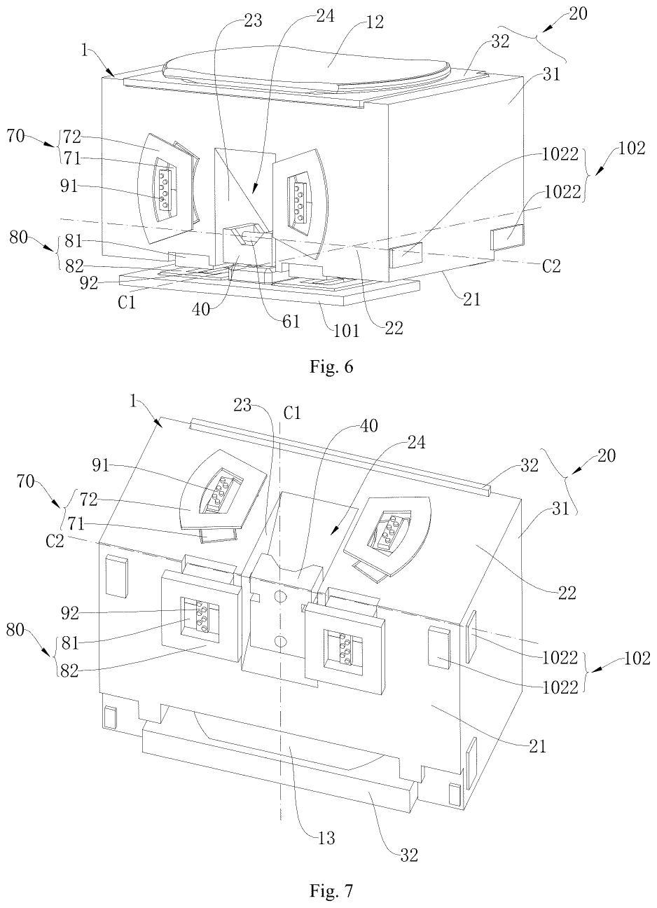

In some examples, as shown in FIGS. 6-7, at least a part of the projection area of the rotation retaining member 40 along the first axis OA1 overlaps with the projection area of the rotation assembly 20 along the first axis OA1, and at least a part of the projection area of the rotation retaining member 40 along the second axis OA2 overlaps with the projection area of the rotation assembly 20 along the second axis OA2, thereby making the structure of the reflection module 1 more compact, which is beneficial for reducing the overall size of the reflection module 1.

In some examples, as shown in FIGS. 6-8, a hollow area 24 is provided on the side surface of the rotation assembly 20 facing away from the reflection member 11, and at least a part of the rotation retaining member 40 is accommodated in the hollow area 24, so that at least a part of the rotation retaining member 40 overlaps with the rotation assembly 20 along a direction of the first axis OA1, and at least a part of the rotation retaining member 40 overlaps with the rotation assembly 20 along a direction of the second axis OA2.

As mentioned above, the pitch supporting part 60 is located between the rotation assembly 20 and the rotation retaining member 40. The pitch supporting part 60 provides a pitch axis C2, which passes through the rotation retaining member 40 and is parallel to the third axis A3. It should be understood that, at least a part of the pitch supporting part 60 is also accommodated in the hollow area 24, so that at least a part of the pitch supporting part 60 overlaps with the rotation assembly 20 along a direction of the first axis OA1, and at least a part of the pitch supporting part 60 is also overlapped with the rotation assembly 20 along a direction of the second axis OA2, so that the structure of the reflection module 1 is more compact, which is conducive to further reducing the overall size of the reflection module 1.

Furthermore, at least a part of the rotation supporting part 50 crimped between the rotation retaining member 40 and the base 101 can also be accommodated in the hollow area 24, so that at least a part of the rotation supporting part 50 overlaps with the rotation assembly 20 along a direction of the first axis OA1, and at least a part of the rotation supporting part 50 overlaps with the rotation assembly 20 along a direction of the second axis OA2, so as to improve the space utilization of the reflection module 1. Furthermore, at least a part of the base 101 may also protrude toward the bottom 21 of the rotation assembly 20 to extend into the hollow area 24. This application does not impose any specific limitation on this.

In at least one example, the two pitch magnets 81 may also be located in the hollow area 24 of the rotation assembly 20, and the rotation supporting part 50 and the rotation retaining member 40 are located between the two pitch magnets 81. That is, at least a part of the rotation supporting part 50 and at least a part of the rotation retaining member 40 overlap with the pitch magnet 81 along a direction of the third axis A3, so that the structure of the reflection module 1 is more compact, and the space of the reflection module 1 can be reasonably utilized, and the size of the reflection module 1 can be reduced.

It is worth mentioning that, the rotation supporting part 50 and the rotation retaining member 40 are located between the two pitch magnets 81, which is also beneficial for arranging the two pairs of pitch magnets 81 and the pitch coils 82 at intervals, thereby helping to reduce the mutual interference between the magnetic fields of the two pitch magnets 81, and helping to improve the accuracy of controlling the pitching movement of the rotation assembly 20 around the pitch axis C2.

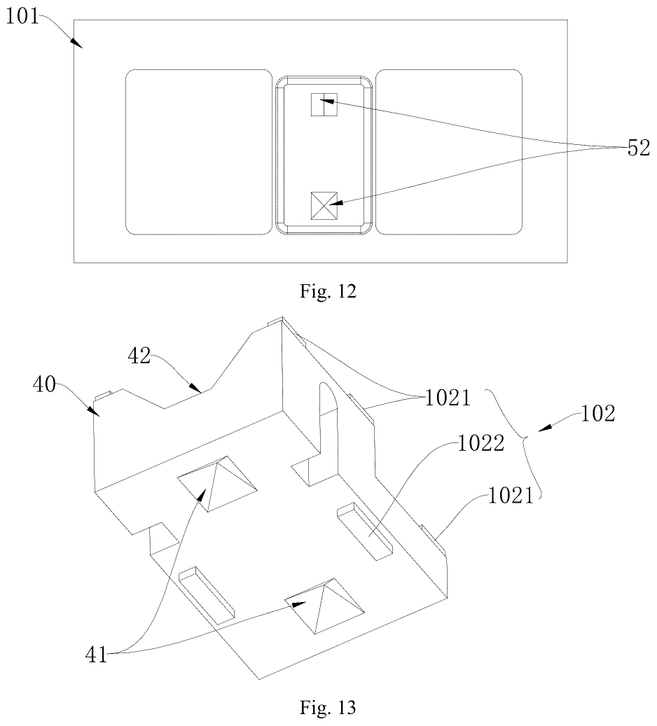

In some examples, as shown in FIGS. 11-12, the rotation supporting part 50 comprises at least two supporting bosses 511, wherein the at least two supporting bosses 511 protrude from one of the rotation retaining member 40 and the base 101 along a direction parallel to the first axis OA1, the at least two supporting bosses 511 are crimped between the rotation retaining member 40 and the base 101, and an imaginary line extending from the rotation axis C1 passes through the at least two supporting bosses 511. That is to say, one of the rotation retaining member 40 and the base 101 is provided with a supporting boss 511, and the supporting boss 511 is able to abut against the other of the rotation retaining member 40 and the base 101 to form a fulcrum, and an imaginary line extending from the rotation axis C1 passes through the fulcrum, so that the rotation retaining member 40 is able to support the rotation assembly 20 to synchronously rotate around the fulcrum relative to the base 101.

Further, as shown in FIGS. 11-12, the other of the rotation retaining member 40 and the base 101 is provided with a supporting groove 52, wherein the supporting groove 52 is used to accommodate the supporting boss 511 so as to limit the supporting boss 511, so that the rotation retaining member 40 can rotate around the rotation axis C1 more stably relative to the base 101. It should be understood that, by controlling the processing accuracy of the supporting boss 511 and the supporting groove 52, it is beneficial for improving the assembly accuracy of the supporting boss 511 and the supporting groove 52 after the reflection module 1 is assembled, thereby reducing the risk of the rotation retaining member 40 tilting relative to the base 101, and reducing the friction between the supporting boss 511 and the supporting groove 52, which is beneficial for improving the controllability and reliability of the rotational movement of the rotation assembly 20, and is beneficial for extending the service life of the base 101 and the rotation retaining member 40. Furthermore, the assembly tolerance among the rotation retaining member 40, the rotation supporting part 50 and the base 101 can be reduced.

In at least one example, the rotation supporting part 50 comprises two supporting bosses 511 spaced apart from each other along a direction parallel to the second axis OA2. It should be understood that, compared with disposing three or more supporting bosses 511, disposing two supporting bosses 511 in this example can help reduce the difficulty of processing and assembly while ensuring that the rotation supporting part 50 reliably supports the rotation retaining member 40, thereby reducing the manufacturing cost of the reflection module 1 and improving the assembly accuracy of the reflection module 1.

In at least one example, as shown in FIG. 12, one of the rotation retaining member 40 and the base 101 is provided with two supporting grooves 52 spaced apart along a direction parallel to the second axis OA2, wherein one of the supporting grooves 52 is implemented as a V-shaped groove, and then the V-shaped supporting groove 52 cooperates with one of the supporting bosses 511 to play the role of positioning the rotation retaining member 40. Furthermore, another supporting groove 52 is implemented as a U-shaped groove to cooperate with another supporting boss 511. It should be understood that, the center line of the U-shaped supporting groove 52 is collinear or nearly collinear with the center line of the V-shaped supporting groove 52, so that the imaginary line where the rotation axis C1 passing through the two supporting bosses 511 is located is parallel to the second axis OA2.

That is to say, the V-shaped supporting groove 52 is conducive to positioning, and the U-shaped supporting groove 52 is convenient for adjustment, which is conducive to reducing the difficulty of assembling the rotation retaining member 40 and the base 101, thereby improving the assembly efficiency, and is conducive to making the two supporting bosses 511 located on a straight line parallel to the second axis OA2 to improve the assembly accuracy. It is worth mentioning that in this example, one of the supporting grooves 52 is implemented as a V-shaped groove, and the other supporting groove 52 is implemented as a U-shaped groove, which is also beneficial for reduce the position accuracy requirements for the two supporting bosses 511, and reduce the position accuracy requirements for the two supporting grooves 52, thereby reducing the processing difficulty of the rotation retaining member 40 and the base 101 and reducing the production cost.

In at least one other example, one of the rotation retaining member 40 and the base 101 is provided with two supporting grooves 52 spaced apart along a direction parallel to the second axis OA2, and both supporting grooves 52 are implemented as U-shaped grooves, which is beneficial for further reducing the processing difficulty of the rotation retaining member 40 and the base 101 and reduce the production cost.

It should be understood that, the supporting groove 52 can also be implemented as a quadrangular pyramid groove, a cylindrical groove, a hemispherical groove, a rectangular groove, etc., and the present application does not impose specific limitations on this. The supporting boss 511 may be implemented as a hemispherical shape, a semi-cylindrical shape, etc., and the present application does not impose any specific limitation on this.

In other examples, as shown in FIGS. 5 and 13-14, the rotation supporting part 50 comprises at least two supporting balls 512 spaced apart along a direction parallel to the second axis OA2, and the rotation retaining member 40 is provided with at least two ball upper grooves 41, and the base 101 is provided with at least two ball lower grooves 1012, and the ball upper grooves 41 and the ball lower grooves 1012 are arranged opposite to each other along a direction parallel to the first axis OA1 to form a movement space between the ball upper grooves 41 and the ball lower grooves 1012; at least two supporting balls 512 are movably clamped in the movement space between the ball upper grooves 41 and the ball lower grooves 1012, and an imaginary line extending from the rotation axis C1 passes through at least two supporting balls 512, so that at least two supporting balls 512 are able to support the rotation retaining member 40 and the rotation assembly 20 to synchronously rotate around the rotation axis C1 relative to the base 101.

It should be understood that, by controlling the machining accuracy of the upper ball groove 41 and the lower ball groove 1012, the imaginary line at which the rotation axis C1 passing through the two supporting balls 512 is located can be parallel or nearly parallel to the second axis OA2, which is beneficial for improving the matching accuracy between the rotation retaining member 40, the supporting balls 512 and the base 101 after the reflection module 1 is assembled, thereby reducing the risk of the rotation retaining member 40 tilting relative to the base 101, and is beneficial for improving the controllability and reliability of the rotational movement of the rotation assembly 20. It is worth mentioning that, the balls can be standard pieces, which is conducive to further reducing the manufacturing difficulty of the reflection module 1, and further reducing the manufacturing cost of the reflection module 1.

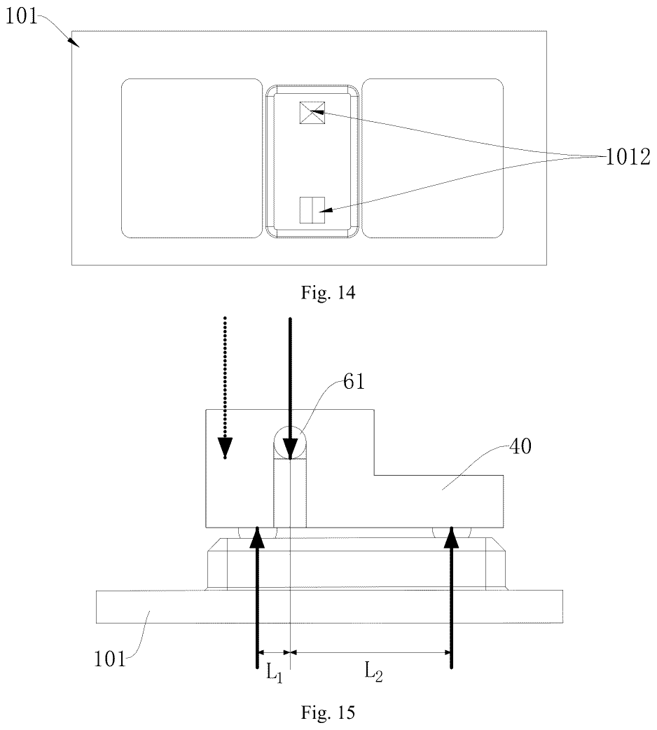

In at least one example, as shown in FIGS. 13-14, the bottom surface of the rotation retaining member 40 is provided with two upper ball grooves 41 spaced apart along a direction parallel to the second axis OA2, and the top surface of the base 101 is provided with two lower ball grooves 1012 spaced apart along a direction parallel to the second axis OA2, and a pair of upper ball grooves 41 and lower ball grooves 1012 arranged opposite to each other along a direction parallel to the first axis OA1 are both implemented as V-shaped grooves; one of the other pair of upper ball grooves 41 and lower ball grooves 1012 arranged opposite to each other along a direction parallel to the first axis OA1 is implemented as a V-shaped groove, and the other is implemented as a U-shaped groove. It should be understood that, clamping the supporting ball 512 by two V-shaped grooves arranged opposite to each other is conducive to positioning, and clamping the supporting ball 512 by a V-shaped groove and a U-shaped groove arranged opposite to each other is convenient for adjustment, which is conducive to reducing the difficulty of assembling the rotation retaining member 40, the supporting ball 512 and the base 101, thereby improving the assembly efficiency, and is conducive to locating the two supporting balls 512 on a straight line parallel to the second axis OA2 so as to improve the assembly accuracy.

It is worth mentioning that in this example, one of the supporting balls 512 is crimped between a V-shaped groove and a U-shaped groove, which is beneficial for reducing the position accuracy requirements for the two ball upper grooves 41 and the position accuracy requirements for the two ball lower grooves 1012, thereby reducing the processing difficulty of the rotation retaining member 40 and the base 101 and reducing the production cost.

It is worth mentioning that, the upper ball groove 41 and the lower ball groove 1012 can also be implemented as quadrangular pyramid grooves, cylindrical grooves, hemispherical grooves, rectangular grooves, etc., respectively, and the present application does not impose specific restrictions on this.

In some examples, as shown in FIGS. 5-6, the pitch supporting part 60 comprises a pivot member 61, which extends along a direction parallel to the third axis A3. The pivot member 61 enables the rotation assembly 20 to be hinged to the rotation retaining member 40 so that the rotation assembly 20 can perform a pitching movement around the pitch axis C2 relative to the rotation retaining member 40. That is, the extending direction of the pivot member 61 is parallel to but not colinear with the third axis A3, and the imaginary line at which the pitch axis C2 is located passes through the pivot member 61. It should be understood that, the pivot member 61 has a high linearity, which is beneficial for reducing the risk of the rotation assembly 20 tilting relative to the rotation retaining member 40 and the base 101, and during the pitching movement of the rotation assembly 20 around the pitch axis C2, it is beneficial for reducing the component motion of the rotation assembly 20 that deviates from the rotation around the imaginary line at which the pitch axis C2 is located, thereby improving the accuracy of the pitching movement of the rotation assembly 20.

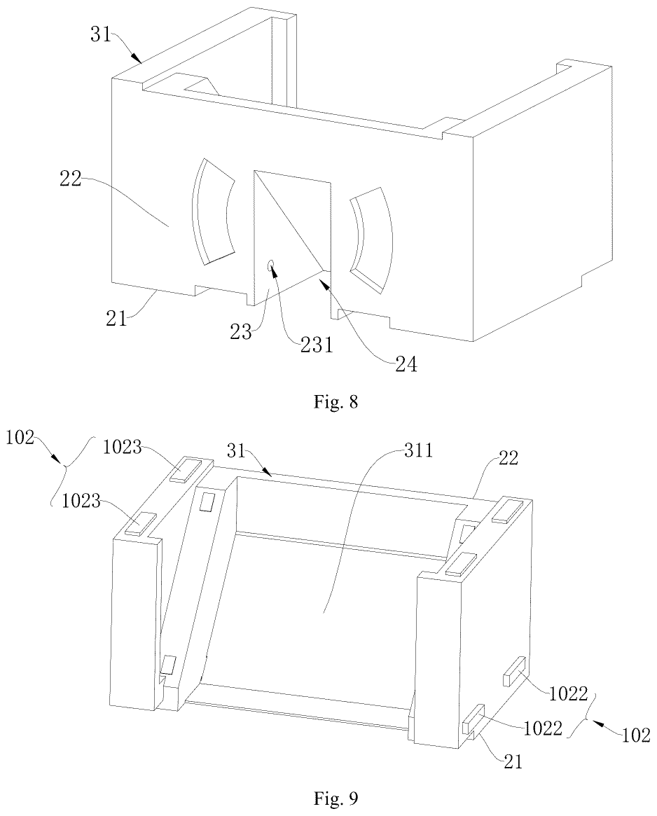

Particularly, as shown in FIGS. 5 and 8, the middle section of the pivot member 61 is inserted into the rotation retaining member 40, and both ends of the pivot member 61 extend toward the rotation assembly 20 along a direction parallel to the third axis A3. The side wall 23 of the rotation assembly 20 facing the rotation retaining member 40 is provided with a slot 231, and the slot 231 can accommodate the end of the pivot member 61 so that the rotation assembly 20 can be rotatably connected to the rotation retaining member 40. It should be understood that, the two slots 231 on the side wall 23 of the rotation assembly 20 are symmetrically arranged relative to the second axis OA2, so that the imaginary line at which the pivot member 61 is projected along the first axis OA1 and the imaginary line at which the line connecting the projections of at least two rotation supporting members 51 along the first axis OA1 is are perpendicular to each other.

It is worth mentioning that, the pivot member 61 is connected to the rotation retaining member 40 and the rotation assembly 20 by insertion, which is conducive to the pivot member 61 being reliably crimped between the rotation assembly 20 and the rotation retaining member 40, thereby improving the structural reliability and stability of the reflection module 1. In addition, the pivot member 61 is connected to the rotation assembly 20 and the rotation retaining member 40 via a slot 231, which is beneficial for reducing the contact area between the pivot member 61 and the rotation assembly 20, as well as reducing the contact area between the pivot member 61 and the rotation retaining member 40, thereby reducing the friction between the pivot member 61 and the rotation assembly 20, as well as reducing the friction between the pivot member 61 and the rotation retaining member 40, which is beneficial for reducing the driving force required to drive the rotation assembly 20 to perform pitching movement around the pitch axis C2, thereby helping to reduce the power consumption of the reflection module 1.

In at least one example, as shown in FIGS. 5, 11 and 13, an avoidance groove 42 is provided on the top of the rotation retaining member 40, which is beneficial for reducing the matching length of the pivot member 61 and the rotation retaining member 40, and is beneficial for further reducing the contact area between the pivot member 61 and the rotation retaining member 40, thereby reducing the friction between the pivot member 61 and the rotation retaining member 40. In addition, by reducing the mating length between the pivot member 61 and the rotation retaining member 40, it is helpful to reduce the assembly difficulty of the pivot member 61 and the rotation retaining member 40, improve the assembly efficiency of the reflection module 1, and help reduce the processing accuracy required for the rotation retaining member 40 and the pivot member 61, thereby reducing the manufacturing cost of the reflection module 1.

In at least one example, the pivot member 61 is rotatably connected to the rotation retaining member 40, and the pivot member 61 is fixedly connected to the rotation assembly 20, which helps to improve the controllability of the pitching movement of the rotation assembly 20. In at least one other example, the pivot member 61 is fixedly connected to the rotation retaining member 40, and the pivot member 61 is rotatably connected to the rotation assembly 20, which helps to avoid the pivot member 61 being non-parallel to the second axis OA2 due to the installation gap between the pivot member 61 and the rotation retaining member 40. In at least one other example, the pivot member 61 is rotatably connected to the rotation retaining member 40, and the pivot member 61 is rotatably connected to the rotation assembly 20, which helps to improve the flexibility of the rotation assembly 20 rotating around the pitch axis C2. This application does not impose any specific limitation on this.

In some example, as shown in FIG. 15, the projection of the pivot member 61 along a direction parallel to the first axis OA1 falls between the projections of at least two rotation supporting members 51 along a direction parallel to the first axis OA1, to prevent the rotation retaining member 40 from being tilted due to the biased supporting force.

It should be understood that, at least two rotation supporting members 51 are spaced apart along a direction parallel to the second axis OA2, and at least two rotation supporting members 51 are respectively arranged close to the two ends of the rotation retaining member 40 along a direction parallel to the second axis OA2, which is beneficial for making the projection of the center of gravity of the rotation retaining member 40 along a direction parallel to the first axis OA1 fall between the projections of the at least two rotation supporting members 51 along a direction parallel to the first axis OA1, so that the at least two rotation supporting members 51 can support the rotation retaining member 40 more stably and reliably.

Viewing from the direction of the third axis A3, as shown in FIG. 15, if the projection of the pivot member 61 along a direction parallel to the first axis OA1 falls outside the projections of at least two rotation supporting members 51 along a direction parallel to the first axis OA1, as shown by the dotted line, that is, the action point of the pivot member 61 on the rotation retaining member 40 along a direction parallel to the first axis OA1 is located outside the action points of at least two rotation supporting members 51 on the rotation retaining member 40 along a direction parallel to the first axis OA1, that is, the rotation retaining member 40 is acted upon by the biased pivot member 61, then the distance between the action point of the pivot member 61 on the rotation retaining member 40 and the center of gravity of the rotation retaining member 40 is farther, that is, the lever arm is longer, which results in a larger torque of the pivot member 61 on the rotation retaining member 40, which may increase the risk of tilting, rotating or even overturning of the rotation retaining member 40.

In this example, as shown by the solid line, the action point of the pivot member 61 on the rotation retaining member 40 along a direction parallel to the first axis OA1 is located between the action points of at least two rotation supporting members 51 on the rotation retaining member 40 along a direction parallel to the first axis OA1. The distance between the action point of the pivot member 61 on the rotation retaining member 40 and the center of gravity of the rotation retaining member 40 is closer, that is, the lever arm is shorter, which results in a smaller torque of the pivot member 61 on the rotation retaining member 40, which is beneficial for reducing the risk of tilting, rotating or even overturning of the rotation retaining member 40, and is beneficial for improving the structural reliability and stability of the reflection module 1.

In some examples, as shown in FIG. 15, among at least two rotation supporting members 51, one of the rotation supporting members 51 is arranged close to the reflection member 11 along a direction parallel to the second axis OA2, and the other rotation supporting member 51 is arranged away from the reflection member 11 along a direction parallel to the second axis OA2, and the distance between the projection of the pivot member 61 along the direction of the first axis OA1 and the projection of the rotation supporting member 51 away from the reflection member 11 along the direction of the first axis OA1 is L₁, and the distance between the projection of the pivot member 61 along the direction of the first axis OA1 and the projection of the rotation supporting member 51 close to the reflection member 11 along the direction of the first axis OA1 is L₂, and L₁≤L₂.

It should be understood that, since the mounting surface 311 of the rotation assembly 20 for supporting the reflection member 11 is tilted, the distance between the rotation assembly 20 and the base 101 along a direction parallel to the first axis OA1 is gradually increased from the side close to the reflection member 11 along a direction parallel to the second axis OA2 to the side away from the reflection member 11. That is to say, on the side away from the reflection member 11 along a direction parallel to the second axis OA2, there is a larger space between the rotation assembly 20 and the base 101 along a direction parallel to the first axis OA1, so as to accommodate the rotation retaining member 40 and the pivot member 61, which is beneficial for making the structure of the reflection module 1 more compact, reduce the size of the reflection module 1, reduce the risk of interference between the rotation assembly 20 and the rotation retaining member 40 during the pitching movement around the pitch axis C2, and improve the movement reliability of the reflection module 1.

In some examples, as shown in FIGS. 6 and 7, the imaginary line at which the projection of the pivot member 61 along a direction parallel to the first axis OA1 is located and the imaginary line at which the projection of the line connecting at least two rotation supporting members 51 along a direction parallel to the first axis OA1 is located are perpendicular to each other. It should be understood that, the first axis OA1, the second axis OA2 and the third axis A3 are perpendicular to each other, and the imaginary line extending along the pivot member 61 is parallel to but not colinear with the third axis A3, so that the pitch axis C2 passing through the pivot member 61 is perpendicular to the first axis OA1 and the second axis OA2 respectively, which is beneficial for avoiding the rotation assembly 20 from tilting relative to the first axis OA1 and the second axis OA2, and further helps to improve the accuracy of the pitching movement of the rotation assembly 20; the imaginary line passing through at least two rotation supporting members 51 is parallel to but not colinear with the second axis OA2, so that the rotation axis C1 passing through the two rotation supporting members 51 is perpendicular to the first axis OA1 and the third axis A3 respectively, which is beneficial for avoiding the rotation assembly 20 and the rotation retaining member 40 from tilting relative to the first axis OA1 and the third axis A3, and further helps to improve the accuracy of the rotational movement of the rotation assembly 20.

It should be understood that, the imaginary line at which the projection of the pivot member 61 along a direction parallel to the first axis OA1 is located and the imaginary line at which the projection of the line connecting at least two rotation supporting members 51 along a direction parallel to the first axis OA1 is located are perpendicular to each other, which is beneficial for decomposing the movement of the rotation assembly 20 into rotations around two mutually perpendicular directions, thereby reducing the component of the movement of the rotation assembly 20 in other directions, thereby improving the control accuracy of the rotational movement and pitching movement of the rotation assembly 20, and reducing the risk of tilting of the rotation carrier and the rotation supporting part 50.

In some examples, the reflection module 1 further comprises a magnetic magnet and a magnetic yoke. The magnetic magnet is provided at one of the rotation assembly 20 and the base 101, and the magnetic yoke is provided at the other of the rotation assembly 20 and the base 101. A magnetic attraction force is generated between the magnetic magnet and the magnetic yoke along a direction parallel to the first axis OA1. Under the action of the magnetic attraction force, the pitch supporting part 60 can be crimped between the rotation assembly 20 and the rotation retaining member 40, and the rotation supporting part 50 can be crimped between the rotation retaining member 40 and the base 101.

That is to say, through the interaction between the magnetic magnet and the magnetic yoke, a magnetic attraction force is provided to the rotation assembly 20 toward the base 101 along the first axis OA1 parallel to the first axis OA1. Under the action of the magnetic attraction force, the pitch supporting part 60, the rotation retaining member 40 and the rotation supporting member 51 are stacked and crimped between the rotation assembly 20 and the base 101.

It should be understood that, as mentioned above, the rotation supporting member 51 is reliably clamped between the rotation retaining member 40 and the base 101 under the action of magnetic attraction force, thereby helping to improve the reliability of the attachment between the rotation assembly 20, the rotation retaining member 40 and the base 101 when the periscope camera module 2 is subjected to external forces such as falling or impact, thereby reducing the risk of separation of the rotation assembly 20, the rotation retaining member 40 and the base 101.

In at least one example, the magnetic yoke is embedded in the base 101, and the pitch magnet 81 and the magnetic magnet are implemented as a common magnet, that is, the pitch magnet 81 can cooperate with the pitch coil 82 to drive the rotation assembly 20 to pitch around the pitch axis C2, and the pitch magnet 81 can cooperate with the magnetic yoke to provide magnetic attraction force, so that the pitch supporting part 60, the rotation retaining member 40 and the rotation supporting member 51 can be stacked and crimped between the rotation assembly 20 and the base 101. It should be understood that, by implementing the pitch magnet 81 and the magnetic magnet as a common magnet, the number of parts of the reflection module 1 can be reduced, which is conducive to making the structure of the reflection module 1 more compact, reducing the number of installation steps and reducing the manufacturing cost.

In at least one example, the magnetic yoke is embedded in the base 101, and the magnetic magnet is arranged at the bottom 21 of the rotation assembly 20 independently of the pitch magnet 81. The magnetic magnet cooperates with the magnetic yoke to provide magnetic attraction force, so that the pitch supporting part 60, the rotation retaining member 40 and the rotation supporting member 51 can be stacked and crimped between the rotation assembly 20 and the base 101. It should be understood that, the magnetic magnet is arranged independently from the pitch magnet 81, which is conducive to more flexible adjustment of the disposing position of the magnetic magnet, thereby improving the reliability of the cooperation between the magnetic magnet and the magnetic yoke.

In some examples, as shown in FIGS. 5-7 and 10, the reflection module 1 further comprises a sensing assembly 90, and the sensing assembly 90 comprises at least one rotation sensing element 91 and at least one pitch sensing element 92 arranged on the base 101, the rotation sensing element 91 and the rotation magnet 71 are arranged opposite to each other along a direction parallel to the second axis OA2, so that the rotation sensing element 91 obtains the rotation magnetic field information of the rotation magnet 71 to sense the stroke of the rotation assembly 20 for rotational movement around the rotation axis C1, and the pitch sensing element 92 and the pitch magnet 81 are arranged opposite to each other along a direction parallel to the first axis OA1, so that the pitch sensing element 92 obtains the pitch magnetic field information of the pitch magnet 81 to sense the stroke of the rotation assembly 20 for pitching movement around the pitch axis C2.

In some examples, the total number of rotation sensing elements 91 and pitch sensing elements 92 is at least three.

In at least one example, the number of the rotation sensing elements 91 is two, and the two rotation sensing elements 91 and the two rotation magnets 71 are arranged opposite to each other respectively along a direction parallel to the second axis OA2. By calculating the rotation magnetic field information obtained by the two rotation sensing elements 91, it is helpful to eliminate the interference of the pitching movement information in the rotational movement, thereby improving the control accuracy of the rotation sensing element 91. Furthermore, the number of the pitch sensing element 92 is one, and the control accuracy of the pitch sensing element 92 can be improved by increasing the coverage area of the magnetic field of the pitch magnet 81, or by using an element with higher sensing accuracy as the pitch sensing element 92 to improve the control accuracy.

In at least one example, the number of pitch sensing elements 92 is two, and the two pitch sensing elements 92 and the two pitch magnets 81 are respectively arranged opposite to each other along a direction parallel to the first axis OA1. By calculating the pitch magnetic field information obtained by the two pitch sensing elements 92, it is helpful to eliminate the interference of rotational movement information in the pitching movement, thereby improving the control accuracy of the pitch sensing element 92. Furthermore, the number of the rotation sensing element 91 is one, and the control accuracy of the rotation sensing element 91 can be improved by increasing the coverage area of the magnetic field of the rotation magnet 71, or by using an element with higher sensing accuracy as the rotation sensing element 91 to improve the control accuracy.

It should be understood that, when the total number of the rotation sensing elements 91 and the pitch sensing elements 92 is three, it is possible to improve the sensing accuracy of the sensing assembly 90 of the reflection module 1, thereby facilitating the miniaturization of the reflection module 1 and reducing the manufacturing cost of the reflection module 1.

It is worth mentioning that, the rotation sensing element 91 and the pitch sensing element 92 may use the same element or different elements, such as a Hall sensor, a driver IC, a TMR sensor, or a rotating gyroscope.

In some examples, as shown in FIGS. 6-7, the magnetic poles of the rotation magnet 71 are distributed along the bending direction of the rotation magnet 71. Under the condition that the rotation magnet 71 rotates around the rotation axis C1 relative to the rotation sensing element 91, along a direction of the second axis OA2, the overlapping area between the magnetic poles of the rotation magnet 71 and the rotation sensing element 91 changes with the rotation angle of the rotation magnet 71. Particularly, as described above, the rotation magnet 71 comprises a first magnetic region 711 and a second magnetic region 712 arranged along a bending direction, and the magnetic poles of the first magnetic region 711 and the second magnetic region 712 are arranged opposite to each other. Further, during the process of the rotation assembly 20 rotating around the rotation axis C1, the rotation magnet 71 is able to move relative to the rotation sensing element 91, so that the overlapping area of the first magnetic region 711 and the rotation sensing element 91 along a direction parallel to the second axis OA2 is increased, and the overlapping area of the second magnetic region 712 and the rotation sensing element 91 along a direction parallel to the second axis OA2 is decreased; or the overlapping area of the first magnetic region 711 and the rotation sensing element 91 along a direction parallel to the second axis OA2 is decreased, and the overlapping area of the second magnetic region 712 and the rotation sensing element 91 along a direction parallel to the second axis OA2 is increased, so that the rotation sensing element 91 is able to obtain the rotation magnetic field information of the rotation magnet 71 so as to sense the stroke of the rotation assembly 20 rotating around the rotation axis C1.

It should be understood that, if the rotation assembly 20 simultaneously has a rotational movement around the rotation axis C1 and a pitching movement around the pitch axis C2, the sensing accuracy of the rotational movement of the rotation assembly 20 or the pitching movement of the rotation assembly 20 will be affected. Therefore, in order to improve the sensing accuracy of the rotation sensing element 91 for the rotational movement of the rotation assembly 20 around the rotation axis C1, it is necessary to reduce the influence of the pitching movement of the rotation assembly 20 around the pitch axis C2 on the rotation sensing element 91; similarly, in order to improve the sensing accuracy of the pitch sensing element 92 for the pitching movement of the rotation assembly 20 around the pitch axis C2, it is necessary to reduce the influence of the rotational movement of the rotation assembly 20 during rotation on the pitch sensing element 92.

In some examples, as described above, the rotation magnet 71 comprises a first rotation magnet 713 and a second rotation magnet 714 spaced apart along a direction parallel to the third axis A3. Further, as described above, the number of rotation sensing elements 91 is two, and the rotation sensing element 91 comprises a first rotation sensing element 911 and a second rotation sensing element 912. Moreover, the first rotation sensing element 911 and the first rotation magnet 713 are arranged opposite to each other along a direction parallel to the second axis OA2, and the second rotation sensing element 912 and the second rotation magnet 714 are arranged opposite to each other along a direction parallel to the second axis OA2. The first rotation sensing element 911 obtains the first rotation magnetic field information T₁ of the first rotation magnet 713, and the second rotation sensing element 912 obtains the second rotation magnetic field information T₂ of the second rotation magnet 714, so that the stroke of the rotation assembly 20 rotating around the rotation axis C1 is calculated by the first rotation magnetic field information T₁ and the second rotation magnetic field information T₂.

It should be understood that, when there is a pitching movement around the pitch axis C2 during the rotational movement of the rotation assembly 20 around the rotation axis C1, there is a certain inclination angle between the first rotation sensing element 911 and the first rotation magnet 713, and there is a certain inclination angle between the second rotation sensing element 912 and the second rotation magnet 714. That is to say, the center line of the first rotation sensing element 911 is not parallel to the center line of the two magnetic poles of the first rotation magnet 713, and the center line of the second rotation sensing element 912 is not parallel to the center line of the two magnetic poles of the second rotation magnet 714, resulting in that the sensing results of the first rotation sensing element 911 and the second rotation sensing element 912 are easily affected by the pitching movement of the rotation assembly 20 around the pitch axis C2.

In the present application, by disposing the first rotation sensing element 911 and the second rotation sensing element 912 on the side surface of the base 101 facing the back 22 of the rotation assembly 20, and then by the cooperation of the first rotation sensing element 911 and the first rotation magnet 713, and the cooperation of the second rotation sensing element 912 and the second rotation magnet 714, the influence caused by the pitching movement around the pitch axis C2 during the rotational movement of the sensing rotation assembly 20 around the rotation axis C1 can be reduced.

Particularly, the first rotation sensing element 911 can obtain the first rotation magnetic field information T₁ of the first rotation magnet 713, and the second rotation sensing element 912 can obtain the second rotation magnetic field information T₂ of the second rotation magnet 714, so as to calculate the center value Tₘ of the rotation assembly 20 rotating around the rotation axis C1, Tₘ=(T₁+T₂)/2; further, the stroke information about the rotation assembly 20 rotating around the rotation axis C1 obtained by the first rotation sensing element 911 is T₁−Tₘ, the stroke information about the rotational movement of the rotation assembly 20 around the rotation axis C1 obtained by the second rotation sensing element 912 is T₂−Tₘ; further, the stroke information about the rotational movement of the rotation assembly 20 around the rotation axis C1 is (T₁−Tₘ)+(T₂−Tₘ), that is, the sum of the stroke information about the rotational movement of the rotation assembly 20 around the rotation axis C1 obtained by the first rotation sensing element 911 and the second rotation sensing element 912.

It should be understood that, when the rotation assembly 20 simultaneously has rotational movement around the rotation axis C1 and pitching movement around the pitch axis C2, the first rotation magnetic field information T₁ and the second rotation magnetic field information T₂ will comprise stroke information of the pitching movement around the pitch axis C2, and the stroke information of the pitching movement comprised in the first rotation magnetic field information T₁ is opposite to the stroke information of the pitching movement comprised in the second rotation magnetic field information T₂, and then the stroke information of the pitching movement is offset by calculating (T₁+T₂)/2, so that there is no interference from the stroke information of the pitching movement in Tₘ, which is beneficial for improving the accuracy of the sensing results of the first rotation sensing element 911 and the second rotation sensing element 912, and thus is beneficial for achieving more accurate closed-loop control of the reflection module.

In some examples, as described above, the first rotation magnet 713 and the second rotation magnet 714 are symmetrically arranged with respect to the second axis OA2, and the magnetic poles of the first rotation magnet 713 and the second rotation magnet 714 are distributed along the bending direction and have N-pole region and S-pole region. Furthermore, the N-pole region and the S-pole region of the first rotation magnet 713 and the second rotation magnet 714 are symmetrically distributed with respect to the second axis OA2. The first rotation sensing element 911 is opposite to at least one of the N-pole region and the S-pole region of the first rotation magnet 713 along a direction parallel to the second axis OA2 so as to sense the first rotation magnetic field information T₁; the second rotation sensing element 912 is opposite to at least one of the N-pole region and the S-pole region of the second rotation magnet 714 along a direction parallel to the second axis OA2 so as to sense the second rotation magnetic field information T₂. It should be understood that, during the rotational movement of the rotation assembly 20, the first rotation sensing element 911 and the second rotation sensing element 912 are respectively opposite to different magnetic poles along a direction parallel to the second axis OA2. That is to say, under the condition that the first rotation sensing element 911 is opposite to one of the N pole region and the S pole region of the first rotation magnet 713, the second rotation sensing element 912 is opposite to the other of the N pole region and the S pole region of the second rotation magnet 714. Furthermore, when the rotation assembly 20 simultaneously has rotational movement around the rotation axis C1 and pitching movement around the pitch axis C2, the first rotation sensing element 911 moves in a different magnetic pole direction relative to the first rotation magnet 713, and the second rotation sensing element 912 moves in a different magnetic pole direction relative to the second rotation magnet 714. In such way, the stroke information of the pitching movement comprised in the first rotation magnetic field information T₁ is opposite to the stroke information of the pitching movement comprised in the second rotation magnetic field information T₂.

It is worth mentioning that, under the condition that there is no interference of pitching movement in the rotational movement of the rotation assembly 20 around the rotation axis C1, the center line of the first rotation sensing element 911 along a direction parallel to the first axis OA1 is parallel to the center line of the two magnetic poles of the first rotation magnet 713, and the center line of the second rotation sensing element 912 along a direction parallel to the first axis OA1 is parallel to the center line of the two magnetic poles of the second rotation magnet 714, which is beneficial for improving the sensing accuracy of the first rotation sensing element 911 and the second rotation sensing element 912.

In other examples, the first rotation magnet 713 and the second rotation magnet 714 are both multi-pole magnets to provide a more uniform and stable magnetic field distribution. Particularly, the first rotation magnet 713 and the second rotation magnet 714 both comprise an N-pole region and an S-pole region along the first axis OA1 and along the second axis OA2, and a neutral region located between the N-pole region and the S-pole region. Under the condition that there is no interference of pitching movement in the rotational movement of the rotation assembly 20 around the rotation axis C1, the neutral region of the first rotation magnet 713 is parallel to the center line of the first rotation sensing element 911 along a direction parallel to the first axis OA1, and the neutral region of the second rotation magnet 714 is parallel to the center line of the second rotation sensing element 912 along a direction parallel to the first axis OA1, which is beneficial for further improving the sensing accuracy of the first rotation sensing element 911 and the second rotation sensing element 912.

In some examples, as shown in FIGS. 6 and 7, as described above, the pitch magnet 81 comprises a first pitch magnet 813 and a second pitch magnet 814 spaced apart along a direction parallel to the third axis A3. Further, as described above, the number of the pitch sensing elements 92 is two, and the pitch sensing element 92 comprises a first pitch sensing element 921 and a second pitch sensing element 922. Furthermore, the first pitch sensing element 921 and the first pitch magnet 813 are arranged opposite to each other along a direction parallel to the first axis OA1, and the second pitch sensing element 922 and the second pitch magnet 814 are arranged opposite to each other along a direction parallel to the first axis OA1. The first pitch sensing element 921 obtains the first pitch magnetic field information E₁ of the first pitch magnet 813, and the second pitch sensing element 922 obtains the second pitch magnetic field information E₂ of the second pitch magnet 814. The rotation stroke of the rotation assembly 20 around the pitch axis C2 is calculated by the first pitch magnetic field information E₁ and the second pitch magnetic field information E₂.

It should be understood that, when there is a rotational movement around the rotation axis C1 during the pitching movement of the rotation assembly 20 around the pitch axis C2, there is a certain tilt angle between the first pitch sensing element 921 and the first pitch magnet 813, and there is a certain tilt angle between the second pitch sensing element 922 and the second pitch magnet 814. That is to say, the center line of the first pitch sensing element 921 is not parallel to the center line of the two magnetic poles of the first pitch magnet 813, and the center line of the second pitch sensing element 922 is not parallel to the center line of the two magnetic poles of the second pitch magnet 814, resulting in that the sensing results of the first pitch sensing element 921 and the second pitch sensing element 922 are easily affected by the rotational movement of the rotation assembly 20 around the rotation axis C1.

In the present application, by disposing a first pitch sensing element 921 and a second pitch sensing element 922 on the side surface of the base 101 facing the bottom 21 of the rotation assembly 20, and then by the cooperation of the first pitch sensing element 921 and the first pitch magnet 813, and the cooperation of the second pitch sensing element 922 and the second pitch magnet 814, the influence caused by the rotational movement around the rotation axis C1 during the pitching movement of the sensing rotation assembly 20 around the pitch axis C2 can be reduced.

Particularly, the first pitch sensing element 921 can obtain the first pitch magnetic field information E₁ of the first pitch magnet 813, and the second pitch sensing element 922 can obtain the second pitch magnetic field information E₂ of the second pitch magnet 814, so as to calculate the center value Eₘ of the pitching movement of the rotation assembly 20 around the pitch axis C2, Eₘ=(E₁+E₂)/2; further, the stroke information about the pitching movement of the rotation assembly 20 around the pitch axis C2 obtained by the first pitch sensing element 921 is E₁−Eₘ, and the stroke information about the pitching movement of the rotation assembly 20 around the pitch axis C2 obtained by the second pitch sensing element 922 is E₂−Eₘ; still further, the stroke information about the pitching movement of the rotation assembly 20 around the pitch axis C2 is (E₁−Eₘ)+(E₂−Eₘ), that is, the sum of the stroke information about the pitching movement of the rotation assembly 20 around the pitch axis C2 obtained by the first pitch sensing element 921 and the second pitch sensing element 922.

It should be understood that, when the rotation assembly 20 simultaneously has rotational movement around the rotation axis C1 and pitching movement around the pitch axis C2, the first pitch magnetic field information E₁ and the second pitch magnetic field information E₂ will comprise stroke information of the rotational movement around the rotation axis C1, and the stroke information of the rotational movement comprised in the first pitch magnetic field information E₁ is opposite to the stroke information of the rotational movement comprised in the second pitch magnetic field information E₂, and then the stroke information of the rotational movement is offset by calculating (E₁+E₂)/2, so that there is no interference from the stroke information of the rotational movement in Eₘ, which is beneficial for improving the accuracy of the sensing results of the first pitch sensing element 921 and the second pitch sensing element 922, and is conducive to achieving more accurate closed-loop control of the reflection module.

It is worth mentioning that, the (T₁+T₂), (T₁−Tₘ), (T₂−Tₘ), (T₁−Tₘ)+(T₂−Tₘ), and (E₁+E₂), (E₁−Eₘ), (E₂−Eₘ), (E₁−Eₘ)+(E₂−Eₘ) mentioned above are not simple addition and subtraction, but involve complex algorithm processing. Particularly, the process of calculating the rotation angle may comprise but is not limited to: 1. Data preprocessing step for magnetic field information, such as converting the output signals of the first rotation sensing element 911, the second rotation sensing element 912, the first pitch sensing element 921 and the second pitch sensing element 922 into digital signals, then filtering and amplifying the signals; 2. Centralized processing of the data or zero mean normalization processing, or translation processing; 3. Calibrating the detection results according to the external environment where the reflection module is located; 4. Debugging and optimizing the algorithm during calculations.

It is worth mentioning that, under the condition that there is no interference of rotational movement in the pitching movement of the rotation assembly 20 around the pitch axis C2, the center line of the first pitch sensing element 921 along a direction parallel to the second axis OA2 is parallel to the center line of the two magnetic poles of the first pitch magnet 813, and the center line of the second pitch sensing element 922 along a direction parallel to the second axis OA2 is parallel to the center line of the two magnetic poles of the second pitch magnet 814, which is beneficial for improving the sensing accuracy of the first pitch sensing element 921 and the second pitch sensing element 922.

In other examples, as described above, both of the first pitch magnet 813 and the second pitch magnet 814 are multi-pole magnets to provide a more uniform and stable magnetic field distribution. Particularly, the first pitch magnet 813 and the second pitch magnet 814 both comprise an N-pole region and an S-pole region along the direction of the first axis OA1 and along the direction of the second axis OA2, and a neutral region located between the N-pole region and the S-pole region. Under the condition that there is no interference of rotational movement in the pitching movement of the rotation assembly 20 around the pitch axis C2, the neutral region of the first pitch magnet 813 is parallel to the center line of the first pitch sensing element 921 along a direction parallel to the second axis OA2, and the neutral region of the second pitch magnet 814 is parallel to the center line of the second pitch sensing element 922 along a direction parallel to the second axis OA2, which is beneficial for further improving the sensing accuracy of the first pitch sensing element 921 and the second pitch sensing element 922.

In other examples, by disposing a rotation sensing magnet independent of the rotation magnet 71 and a pitch sensing magnet independent of the pitch magnet 81, the influence of the magnetic field between the rotation magnet 71 and the rotation coil 72 on the magnetic field of the rotation sensing magnet can be reduced, and the influence of the magnetic field between the pitch magnet 81 and the pitch coil 82 on the magnetic field of the pitch sensing magnet can be reduced, which is beneficial for improving the sensing accuracy of the rotation sensing element 91 and the pitch sensing element 92.

In some examples, as shown in FIGS. 11 and 13, the reflection module 1 further comprises a buffer part 102, and the buffer part 102 comprises a first buffer member 1021, and the first buffer member 1021 is arranged on at least one of the rotation assembly 20 and the rotation retaining member 40, so that the first buffer member 1021 is located between the rotation assembly 20 and the rotation retaining member 40. During the pitching movement of the rotation assembly 20 around the pitch axis C2, the first buffer member 1021 firstly contacts with the rotation assembly 20 or the rotation retaining member 40, and then plays a buffering role to avoid the collision between the rotation assembly 20 and the rotation retaining member 40, which is beneficial for protecting the rotation assembly 20 and the rotation retaining member 40, so as to reduce the risk of damage to the rotation assembly 20 and the rotation retaining member 40, thereby extending the service life of the periscope camera module 2. In addition, the first buffer member 1021 is spaced between the rotation assembly 20 and the rotation retaining member 40, so as to achieve a low noise effect, which is beneficial for improving user experience.

In some examples, as shown in FIGS. 11 and 13, the buffer part 102 further comprises a second buffer member 1022, and the second buffer member 1022 is arranged on at least one of the rotation retaining member 40 and the base 101, so that the second buffer member 1022 is located between the rotation retaining member 40 and the base 101. During the rotational movement of the rotation retaining member 40 around the rotation axis C1, the second buffer member 1022 firstly contacts with the rotation retaining member 40 or the base 101, and then plays a buffering role to avoid collision between the rotation retaining member 40 and the base 101, which is beneficial for protecting the rotation retaining member 40 and the base 101, so as to reduce the risk of damage to the rotation retaining member 40 and the base 101, thereby extending the service life of the periscope camera module 2. In addition, the second buffer member 1022 is spaced between the rotation retaining member 40 and the base 101, so as to achieve a low noise effect, which is beneficial for improving the user experience.

In some examples, as shown in FIG. 9, the second buffer member 1022 can also be arranged on at least one of the rotation assembly 20 and the base 101, so that the second buffer member 1022 is located between the rotation assembly 20 and the base 101. During the rotational movement of the rotation assembly 20 around the rotation axis C1, the second buffer member 1022 firstly contacts with the rotation assembly 20 or the base 101, and then plays a buffering role to avoid collision between the rotation assembly 20 and the base 101, which is beneficial for protecting the rotation assembly 20 and the base 101, so as to reduce the risk of damage to the rotation assembly 20 and the base 101, thereby extending the service life of the periscope camera module 2.

In some examples, as shown in FIG. 9, the buffer part 102 further comprises a third buffer member 1023, and the third buffer member 1023 is arranged on at least one of the rotation assembly 20 and the base 101, so that the third buffer member 1023 is located between the rotation assembly 20 and the base 101. During the movement of the rotation assembly 20 along the first axis OA1, the third buffer member 1023 firstly contacts with the rotation assembly 20 or the base 101 to avoid the collision between the rotation assembly 20 and the base 101. It should be understood that, when the periscope camera module 2 falls, the impact force of the fall may cause the rotation assembly 20 to separate from the base 101, thereby causing the rotation assembly 20 to collide with the base 101. The third buffer member 1023 can play a buffering role, which is beneficial for protecting the rotation assembly 20 and the base 101, so as to reduce the risk of damage to the rotation assembly 20 and the base 101, thereby extending the service life of the periscope camera module 2. In addition, the third buffer member 1023 is spaced between the rotation assembly 20 and the base 101, so as to achieve a low noise effect, which is beneficial for improving user experience.

In some examples, as shown in FIG. 4, the reflection module 1 further comprises a first lens 12, which is supported by a rotation assembly 20 and arranged close to the object side. The first axis OA1 passes through the reflection member 11 and the first lens 12, and the rotation assembly 20 is suitable for carrying and driving the first lens 12 and the reflection member 11 to synchronously rotate around the rotation axis C1 and/or synchronously pitch around the pitch axis C2.

It should be understood that, the rotation assembly 20 carries and drives the first lens 12 and the reflection member 11 to synchronously rotate around the rotation axis C1 and/or synchronously pitch around the pitch axis C2, which is beneficial for reducing the overall size of the periscope camera module 2. Particularly, if only the reflection member 11 is driven to rotate around the rotation axis C1 and/or around the pitch axis C2, while the first lens 12 is fixed, the first lens 12 needs to be fixed to the light incident side of the reflection member 11 through the base 101. In order to avoid interference between the rotation assembly 20 and the first lens 12 during rotation, a larger gap needs to be reserved between the first lens 12 and the rotation assembly 20, which will inevitably lead to an increase in the height dimension of the reflection module 1. Furthermore, since the base 101 has a relatively large size, the first lens 12 may need to be relatively large in size in order to be adapted to be installed on the base 101, which is not conducive to achieving the miniaturization and lightweight of the periscope camera module 2.

In the present application, the first lens 12 is installed on the rotation assembly 20. Since the size of the rotation assembly 20 is smaller than the base 101, the first lens 12 can be installed and fixed using a smaller size, which is beneficial for reducing the size of the first lens 12 and reducing the weight of the first lens 12. In addition, there is no need to reserve a large gap between the first lens 12 and the reflection member 11 for the reflection member 11 to rotate independently, that is, the gap between the first lens 12 and the reflection member 11 can be smaller, which is conducive to making the structure of the reflection module 1 more compact.

In some examples, the first lens 12 has at least one convex surface, so that the first lens 12 has positive optical power for converging light. It is worth mentioning that, the first lens 12 defines a first axis OA1. It should be understood that, the light along the first axis OA1 is converged after passing through the first lens 12, so as to increase the amount of light entering without changing the physical aperture of the periscope camera module 2; that is to say, it is equivalent to increasing the effective diaphragm of the periscope camera module 2.

Furthermore, the light rays converged by the first lens 12 remain converged after being reflected by the reflection member 11, thereby helping to reduce the size of each optical lens in the lens module 104 of the periscope camera module 2 along a direction parallel to the first axis OA1, thereby reducing the shoulder height of the periscope camera module 2, and helping to realize the miniaturization of the periscope camera module 2.

Furthermore, after the light is converged by the first lens 12, it is incident on the reflection member 11, so that the reflection point of the converged light at the outermost position on the reflection member 11 is closer to the first axis OA1. That is to say, compared with the light being incident on the reflection member 11 in parallel, the area of the reflection surface 111 of the reflection member 11 required by the present application is smaller, which is beneficial for reducing the size of the reflection member 11, thereby reducing the overall height of the periscope camera module 2.

In at least one example, both of the object side surface and the image side surface of the first lens 12 are convex surfaces, so that the light is refracted twice when passing through the first lens 12, which is beneficial for enhancing the convergence effect of the first lens 12 on the light, thereby reducing the gap between the first lens 12 and the reflection member 11, and making the structure of the reflection module 1 more compact.

In some examples, the first lens 12 is a non-trimmed lens, which is helpful to reduce the difficulty of processing the first lens 12 and further reduce the production cost of the reflection module 1. In some other examples, the first lens 12 is a trimmed lens, which is beneficial for reducing the size of the reflection module 1 along a direction parallel to the first axis OA1. This application does not impose any specific limitation on this.

In some examples, the rotation assembly 20 is suitable for carrying and driving the first lens 12 and the reflection member 11 to synchronously rotate around the rotation axis C1 and/or synchronously pitch around the pitch axis C2, so that the relative position and relative angle between the first lens 12 and the reflection member 11 are stable. That is to say, in the process of light passing through the first lens 12 and being incident on the reflection member 11, the stability of the propagation path and propagation angle of the light can be maintained, which is not only beneficial for improving the imaging clarity of the periscope camera module 2, but also beneficial for enhancing the overall image quality of the periscope camera module 2.

It should be understood that, if during an optical image stabilization operation, the rotation assembly 20 only carries the reflection member 11 to perform rotational movement around the rotation axis C1 and/or pitching movement around the pitch axis C2, while the first lens 12 is fixed, the propagation path and angle of the light between the first lens 12 and the reflection member 11 will be affected. This may cause the light to produce a propagation path and angle beyond the image stabilization requirements after being converged and reflected by the first lens 12 and the reflection member 11, which may further cause problems, such as image blur, astigmatism or distortion, thereby affecting the final imaging quality of the periscope camera module 2.

However, in the present application, the rotation assembly 20 is suitable for carrying and driving the first lens 12 and the reflection member 11 to synchronously perform rotational movement around the rotation axis C1 and/or pitching movement around the pitch axis C2, so that the propagation path and angle of the light between the first lens 12 and the reflection member 11 are stable, which is beneficial for reducing the movement of the focusing position of the light when it propagates to the photosensitive module 108, thereby improving the final imaging quality of the periscope camera module 2.

It is worth mentioning that, since the rotation assembly 20 carries the first lens 12 and the reflection member 11 to move synchronously, the variables that need to be considered during the anti-shake operation can be reduced, which is conducive to simplifying the driving structure and improving reliability, and can reduce the research and development difficulty and manufacturing difficulty of the reflection module 1 and the periscope camera module 2, which is conducive to reducing time cost and production cost.

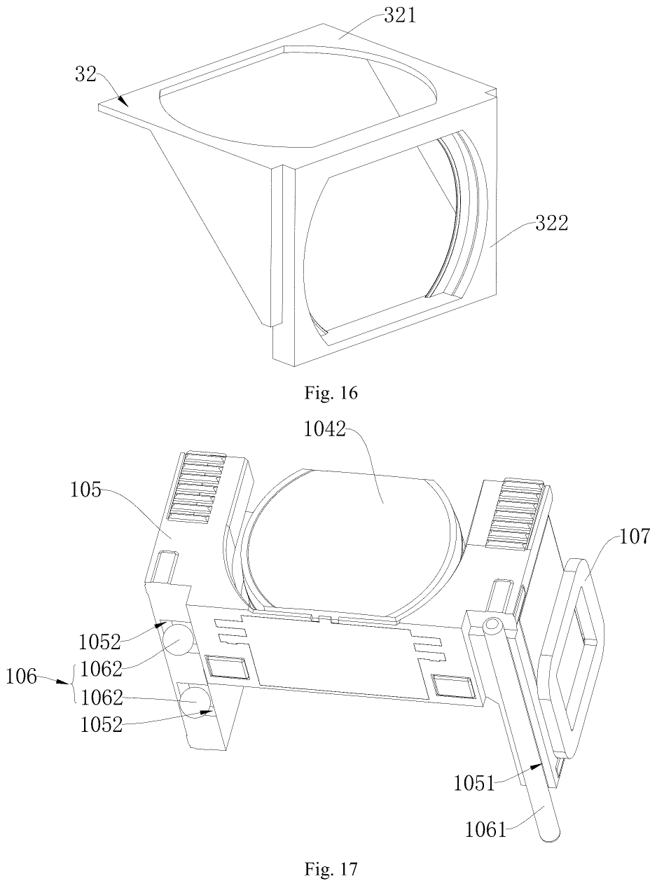

In some examples, as shown in FIGS. 4 and 16, the rotation assembly 20 comprises a rotation bracket 31 and a fixing bracket 32, and the fixing bracket 32 is integrally or separately arranged on the rotation bracket 31. Particularly, the rotation bracket 31 has a mounting surface 311 for fixing the reflection member 11. The fixing bracket 32 has a first fixing part 321, which is arranged opposite to the mounting surface 311 along the first axis OA1 and is used to mount the first lens 12. The rotation bracket 31 can drive the fixing bracket 32 to synchronously rotate around the rotation axis C1 and/or synchronously pitch around the pitch axis C2, thereby making the first lens 12 and the reflection member 11 move synchronously.

It should be understood that, the rotation bracket 31 and the fixing bracket 32 are suitable for being driven to synchronously perform pitching movement around the pitch axis C2 relative to the rotation retaining member 40; and the rotation bracket 31, the fixing bracket 32 and the rotation retaining member 40 are suitable for being driven to synchronously perform rotational movement around the rotation axis C1 relative to the base 101. Furthermore, the reflection member 11 is fixed to the mounting surface 311 of the rotation bracket 31, and the first lens 12 is fixed to the first fixing part 321 of the fixing bracket 32, so that light is emitted from the first lens 12 to the reflection member 11 along the first axis OA1. The first lens 12 and the reflection member 11 are driven as a whole through the rotation bracket 31 and the fixing bracket 32 to perform rotational movement around the rotation axis C1 and/or pitching movement around the pitch axis C2, which is beneficial for simplifying the structure of the reflection module 1.

In a particular example, the rotation bracket 31 and the fixing bracket 32 are separately arranged to facilitate the installation of the reflection member 11 on the rotation bracket 31 and the installation of the first lens 12 on the fixing bracket 32, which is conducive to reducing the difficulty of installation, and the two processes can be carried out simultaneously, which is conducive to improving production efficiency. In another particular example, the rotation bracket 31 and the fixing bracket 32 are integrally formed, which is beneficial for reducing the number of parts, thereby reducing the installation process and improving production efficiency. This application does not impose any specific limitation on this.

In some examples, a first gap 3211 is defined between the first fixing part 321 and the mounting surface 311 of the rotation bracket 31, and at least a part of the first lens 12 extends into the first gap 3211, thereby making the arrangement of the first fixing part 321, the first lens 12, the reflection member 11 and the rotation bracket 31 more compact along a direction parallel to the first axis OA1, which is beneficial for reducing the size of the reflection module 1 along a direction parallel to the first axis OA1, thereby reducing the height of the periscope camera module 2.

In some examples, as shown in FIG. 4, the reflection module 1 further comprises a second lens 13, which is supported by the rotation assembly 20 and arranged close to the image side. The second axis OA2 passes through the reflection member 11 and the second lens 13. The reflection member 11 is supported by the rotation assembly 20 and is located between the first lens 12 and the second lens 13 to reflect the light incident from the object side to the image side. The rotation assembly 20 is suitable for carrying and driving the first lens 12, the reflection member 11 and the second lens 13 to synchronously rotate around the rotation axis C1 and/or synchronously pitch around the pitch axis C2. Referring to the above content about the synchronous movement of the first lens 12 and the reflection member 11, such content will not be repeated herein.

In some examples, the second lens 13 has at least one concave surface, so that the second lens 13 has negative optical power for expanding light. It is worth mentioning that, the second lens 13 defines a second axis OA2. Particularly, the second lens 13 has a negative optical power, so as to expand the light, so that the light along the second axis OA2 is expanded after passing through the second lens 13.

It should be understood that, by disposing a second lens 13 with a beam expanding function, the light focused by the first lens 12 can be diffused after passing through the second lens 13, thereby increasing the coverage area of the light reaching the photosensitive chip, and thus the movement stroke of the reflection member 11 has relatively little effect on the position of the light on the photosensitive chip. The difference between the MTF design value of the periscope camera module 2 at a unit jitter angle and the MTF design value at a static state is small, so that the periscope camera module 2 can obtain clearer images in motion, vibration or jitter usage scenarios.

In some examples, as shown in FIGS. 4 and 16, the fixing bracket 32 also has a second fixing part 322 connected to the first fixing part 321, and the second fixing part 322 and the mounting surface 311 of the rotation bracket 31 are arranged opposite to each other along the second axis OA2, and are used to install the second lens 13. The rotation bracket 31 can drive the fixing bracket 32 to synchronously rotate around the rotation axis C1 and/or synchronously pitch around the pitch axis C2, thereby causing the first lens 12, the reflection member 11 and the second lens 13 to move synchronously. Referring to the above content about the synchronous movement of the fixing bracket 32 and the rotation bracket 31, such content will not be repeated herein.

In some examples, a second gap 3221 is defined between the second fixing part 322 and the mounting surface 311 of the rotation bracket 31, and at least a part of the second lens 13 extends into the second gap 3221, thereby making the arrangement of the rotation bracket 31, the reflection member 11, the second fixing part 322 and the second lens 13 more compact along a direction parallel to the second axis OA2, which is beneficial for reducing the size of the reflection module 1 along a direction parallel to the second axis OA2, thereby reducing the length of the periscope camera module 2.

In at least one example, the reflection member 11 is implemented as a reflect mirror, which comprises a reflection surface 111 and a fixing surface 112. The reflection surface 111 is used to reflect light, and the fixing surface 112 is used to be fixed to the mounting surface 311 of the rotation bracket 31. It should be understood that compared with the prism, the reflect mirror in this example has a lighter weight and a smaller size, which can reduce the space occupied by the reflection module 1 in the periscope camera module 2, thereby facilitating the miniaturization of the periscope camera module 2. In addition, the size and power of a motor required to drive the reflect mirror are smaller, and it is beneficial for improving the anti-shake effect. It is worth mentioning that, the reflection member 11 may also be implemented as a prism, and the present application does not impose any specific limitation on this.

A periscope camera module 2, as shown in FIGS. 1 and 4, comprises: the above reflection module 1 which is configured to reflect the light incident from a first axis OA1 to a second axis OA2, wherein the first axis OA1 intersects with the second axis OA2; a lens module 104 configured to receive the light from the reflection module 1 and continue to propagate the light along the second axis OA2; a photosensitive module 108 configured to receive the light and perform imaging; a base body 109 having an accommodating cavity 1091, wherein the reflection module 1 and the lenses module 104 are arranged in the accommodating cavity 1091, and the base 101 of the reflection module 1 is integrally or separately arranged on the base body 109; and a shell 103 which covers on the base body 109.

It should be understood that, the rotation supporting part 50 of the reflection module 1 is able to carry the rotation retaining member 40 and the rotation assembly 20, and drive the reflection member 11 to rotate around the rotation axis C1, so that the image on the photosensitive surface of the photosensitive module 108 produces an effect of rotating around the rotation axis C1, thereby compensating for the rotational jitter and tilt jitter of the periscope camera module 2 during use, which is beneficial for reducing the aberration and improving the final imaging quality of the periscope camera module 2.

In some examples, as shown in FIGS. 1 and 4, the lens module 104 comprises a plurality of lens pieces, and the lens module 104 is used to image light onto a photosensitive surface of the photosensitive module 108. Particularly, the lens module 104 comprises a first lens group 1041 and a second lens group 1042, and the first lens group 1041 and the second lens group 1042 are sequentially arranged along a direction of the second axis OA2.

In a particular example, as shown in FIGS. 1 and 4, the first lens group 1041 is a fixed lens group, and the second lens group 1042 is a focusing lens group. That is to say, the first lens group 1041 is fixed on the base body 109, and the second lens group 1042 is carried on the lens carrier 105. The lens carrier 105 is driven by the focus driving part 107 to carry the second lens group 1042 to move along the second axis OA2, thereby realizing the optical focusing function of the periscope camera module 2 and switching the imaging mode of the periscope camera module 2. Particularly, the focus driving part 107 may be implemented as a VCM motor, an SMA motor or a piezoelectric motor, and this application does not impose any specific limitation on this.

It should be understood that, the lens module 104 may further comprise a third lens group and/or a fourth lens group, wherein the third lens group and/or the fourth lens group may move along the second axis OA2 to achieve an optical zoom function, and the present application does not impose any specific limitation on this.

In some examples, as shown in FIG. 17, a supporting member 106 is provided between the bottom surface of the lens carrier 105 and the base 109 to support and guide the lens carrier 105 to move relative to the base 109 along a direction of the second axis OA2, which is beneficial for improving the reliability of the relative movement between the lens carrier 105 and the base 109 and reducing the friction resistance during relative movement. It can be understood that, the supporting member 106 can be implemented as a guide rod 1061 or a lens ball 1062, and the present application does not impose any specific limitation on this.

In a particular example, the lens carrier 105 is supported by the guide rod 1061 and the lens ball 1062. Particularly, the guide rod 1061 is extended and disposed on the base body 109 along a direction parallel to the second axis OA2, the guide groove 1051 is arranged on one side of the bottom surface of the lens carrier 105, and the guide rod 1061 is adapted to be installed in the guide groove 1051, and then the lens carrier 105 is guided to move relative to the base body 109 along the second axis OA2 through the cooperation between the guide rod 1061 and the guide groove 1051. Furthermore, at least one lens ball 1062 is rollably arranged on the other side of the bottom surface of the lens carrier 105, and the lens ball 1062 cooperates with the guide rod 1061 to provide a supporting plane, which is conducive to more stably supporting the movement of the lens carrier 105.

In another particular example, the bottom surface of the lens carrier 105 is supported by two guide rods 1061. Particularly, two guide rods 1061 are arranged on the base body 109 at intervals along a direction parallel to the third axis A3, and the two guide rods 1061 extend along a direction parallel to the second axis OA2. Two guide grooves 1051 are provided on the bottom surface of the lens carrier 105. The guide rods 1061 are adapted to be installed in the guide grooves 1051 to support and guide the lens carrier 105 to move relative to the base body 109 along the second axis OA2.

In another particular example, the lens carrier 105 is supported by at least three non-collinear lens balls 1062. Particularly, ball grooves 1052 are respectively formed on the bottom surface of the lens carrier 105 and the surface of the base body 109 facing the lens carrier 105, so as to limit the positions of at least three lenses balls 1062 between the lens carrier 105 and the base body 109. The lens balls 1062 are matched with the ball grooves 1052 to provide a support plane and guide the lens carrier 105 to move relative to the base body 109 along the second axis OA2.

In some examples, the photosensitive module 108 comprises a chip circuit board, a photosensitive chip, and a plurality of electronic components. Particularly, the photosensitive chip and multiple electronic components are electrically connected to the chip circuit board. The photosensitive chip is used to receive the external light collected by the reflection module 1 for imaging, and is electrically connected to external electronic equipment through the chip circuit board. It should be understood that, the multiple electronic components include but are not limited to passive electronic devices such as resistors and capacitors, driver chips, storage chips, etc.

Furthermore, the photosensitive module 108 further comprises a filter assembly comprising a filter element. The filter element is used to filter the incident light entering the photosensitive chip, so as to filter out stray light such as infrared light that is not necessary for imaging in the incident light. It should be understood that, the filter element is maintained on the light sensing path of the photosensitive chip, and is arranged between the lens module 104 and the photosensitive chip.

Furthermore, the filter assembly further comprises a filter bracket having a light hole. The filter element is mounted and fixed on the filter bracket, and corresponds to at least a part of the photosensitive area of the photosensitive chip. The incident light passing through the lens module 104 is incident on the photosensitive chip through the light hole. Particularly, the filter element can be attached to the filter bracket face up or face down.

In a particular example, the filter bracket is fixed to the chip circuit board. It is worth mentioning that, the photosensitive module 108 is fixed to the image side of the filter element through a filter bracket; and the photosensitive module 108 can also be fixed to the image side of the filter element through a chip circuit board, and this application does not impose specific restrictions on this.

The basic principles, main features and advantages of the present application are described above. Those skilled in the art should understand that the present application is not limited to the above examples. The above examples and the specification only describe the principles of the present application. Various changes and improvements may be made to the present application without departing from the spirit and scope of the present application. These changes and improvements all fall within the protection scope of the present application. The protection scope of the present application is defined by the appended claims and their equivalents.

1. A reflection module, characterized by comprising:
a reflection member for reflecting light incident from a first axis to a second axis, wherein the first axis intersects with the second axis;
a rotation assembly for supporting the reflection member;
a base having an internal space;
a rotation retaining member, wherein the rotation assembly, the rotation retaining member, and the base are stacked along a direction parallel to the first axis;
a pivot member which extends along a direction parallel to the third axis, wherein the pivot member is located between the rotation assembly and the rotation retaining member, and the pivot member provides a pitch axis, and the third axis intersects with the first axis and the second axis; and
a rotation supporting part located between the rotation assembly and the base along a direction parallel to the first axis, wherein the rotation supporting part provides a rotation axis which passes through the rotation supporting part and is parallel to the second axis;
wherein an imaginary line at which the projection of the pivot member along a direction parallel to the first axis is located and an imaginary line at which the projection of the rotation supporting part along a direction parallel to the first axis is located are perpendicular to each other.

2. The reflection module according to claim 1, wherein the rotation supporting part comprises at least two rotation supporting members spaced apart along a direction parallel to the second axis, the at least two rotation supporting members are crimped between the rotation assembly and the base, and the at least two rotation supporting members form a rotation axis, and the rotation axis and the second axis are parallel to each other but are not colinear.

3. The reflection module according to claim 2, wherein the reflection module further comprises a pitch supporting part, and the rotation supporting part is capable of supporting the rotation retaining member and the rotation assembly to perform rotational movement around the rotation axis relative to the base, and the pitch supporting part is located between the rotation assembly and the rotation retaining member, and the pitch supporting part provides a pitch axis which is parallel to the third axis and is not colinear with the third axis, so that the rotation assembly is capable of performing pitching movement around the pitch axis relative to the rotation retaining member.

4. The reflection module according to claim 3, wherein at least a part of the projection area of the rotation retaining member along the first axis overlaps with the projection area of the rotation assembly along the first axis, and at least a part of the projection area of the rotation retaining member along the second axis overlaps with the projection area of the rotation assembly along the second axis.

5. The reflection module according to claim 3, wherein the reflection module further comprises a pitch driving part and a rotation driving part, and the pitch driving part is located at the bottom of the rotation assembly, and the rotation driving part is located at the back of the rotation assembly, and the pitch driving part and the rotation driving part are arranged on different sides relative to the rotation assembly, and the pitch driving part comprises at least one pitch magnet and at least one pitch coil, and the pitch magnet and the pitch coil are arranged opposite to each other along a direction parallel to the first axis, and are suitable for cooperating to drive the rotation assembly to perform pitching movement around the pitch axis relative to the rotation retaining member, and the rotation driving part comprises at least one rotation magnet and at least one rotation coil, and the rotation magnet and the rotation coil are arranged opposite to each other along a direction parallel to the second axis, and are suitable for cooperating to drive the rotation assembly to rotate around the rotation axis relative to the base.

6. The reflection module according to claim 5, wherein the rotation magnet is curved in a plane perpendicular to the second axis, and the center of curvature of the rotation magnet is close to the second axis.

7. The reflection module according to claim 6, wherein the rotation magnet comprises a first magnetic region and a second magnetic region arranged along a bending direction, and the magnetic poles of the first magnetic region and the second magnetic region are oppositely arranged, and the rotation magnet comprises a first rotation magnet and a second rotation magnet spaced apart along a direction parallel to the third axis, and the magnetic poles of the first rotation magnet and the second rotation magnet are symmetrically arranged relative to the second axis.

8. The reflection module according to claim 7, wherein during the rotational movement of the rotation assembly around the rotation axis, along a direction of the second axis, the changes of the overlapping area between the first magnetic region of the rotation magnet and the rotation coil and the overlapping area between the second magnetic region of the rotation magnet and the rotation coil are opposite to each other.

9. The reflection module according to claim 3, wherein the rotation supporting part comprises at least two supporting bosses, and the at least two supporting bosses protrude from one of the rotation retaining member and the base along a direction parallel to the first axis, and the at least two supporting bosses are crimped between the rotation retaining member and the base, and an imaginary line extending from the rotation axis passes through the at least two supporting bosses.

10. The reflection module according to claim 3, wherein the rotation supporting part comprises at least two supporting balls spaced apart along a direction parallel to the second axis, and the rotation retaining member is provided with at least two ball upper grooves, and the base is provided with at least two ball lower grooves, and the ball upper grooves and the ball lower grooves are arranged opposite to each other along a direction parallel to the first axis, and the at least two supporting balls are movably clamped between the ball upper grooves and the ball lower grooves, and an imaginary line extending from the rotation axis passes through the at least two supporting balls.

11. The reflection module according to claim 3, wherein the pitch supporting part comprises a pivot member which is rotatably connected to the rotation retaining member and/or the rotation assembly, so that the rotation assembly can perform a pitching movement around the pitch axis relative to the rotation retaining member.

12. The reflection module according to claim 11, wherein a projection of the pivot member along a direction parallel to the first axis falls between projections of the at least two rotation supporting members along a direction parallel to the first axis.

13. The reflection module according to claim 12, wherein among the at least two rotation supporting members, one of the rotation supporting members is arranged close to the reflection member along a direction parallel to the second axis, and the other rotation supporting member is arranged away from the reflection member along a direction parallel to the second axis, and the distance between the projection of the pivot member and the projection of the rotation supporting member away from the reflection member is L₁, and the distance between the projection of the pivot member and the projection of the rotation supporting member close to the reflection member is L₂, and L₁≤L₂.

14. The reflection module according to claim 11, wherein an imaginary line at which the projection of the pivot member along a direction parallel to the first axis is located and an imaginary line at which the projection of a line connecting the at least two rotation supporting members along a direction parallel to the first axis is located are perpendicular to each other.

15. The reflection module according to claim 3, wherein the reflection module further comprises a magnetic magnet and a magnetic yoke, and the magnetic magnet is arranged at one of the rotation assembly and the base, and the magnetic yoke is arranged at the other of the rotation assembly and the base, and a magnetic attraction force is generated between the magnetic magnet and the magnetic yoke along a direction parallel to the first axis, and under the action of the magnetic attraction force, the pitch supporting part is crimped between the rotation assembly and the rotation retaining member, and the rotation supporting part is crimped between the rotation retaining member and the base.

16. The reflection module according to claim 5, wherein the reflection module further comprises a sensing assembly which comprises at least one rotation sensing element and at least one pitch sensing element provided at the base, the rotation sensing element and the rotation magnet are arranged opposite to each other along a direction parallel to the second axis, so that the rotation sensing element obtains the rotation magnetic field information of the rotation magnet, and the pitch sensing element and the pitch magnet are arranged opposite to each other along a direction parallel to the first axis, so that the pitch sensing element obtains the pitch magnetic field information of the pitch magnet.

17. The reflection module according to claim 16, wherein the magnetic poles of the rotation magnet are distributed along the bending direction of the rotation magnet, and under the condition that the rotation magnet rotates around the rotation axis relative to the rotation sensing element, along a direction of the second axis, the overlapping area between the magnetic poles of the rotation magnet and the rotation sensing element changes with the rotation angle of the rotation magnet.

18. The reflection module according to claim 16, wherein the rotation magnet comprises a first rotation magnet and a second rotation magnet spaced apart along a direction parallel to the third axis, and the rotation sensing element comprises a first rotation sensing element and a second rotation sensing element, and the first rotation sensing element and the first rotation magnet are arranged opposite to each other along a direction parallel to the second axis, and the second rotation sensing element and the second rotation magnet are arranged opposite to each other along a direction parallel to the second axis, the first rotation sensing element obtains first rotation magnetic field information of the first rotation magnet, and the second rotation sensing element obtains second rotation magnetic field information of the second rotation magnet, so that the stroke of the rotation assembly rotating around the rotation axis can be calculated by the first rotation magnetic field information and the second rotation magnetic field information.

19. The reflection module according to claim 16, wherein the pitch magnet comprises a first pitch magnet and a second pitch magnet spaced apart along a direction parallel to the third axis, the pitch sensing element comprises a first pitch sensing element and a second pitch sensing element, and the first pitch sensing element and the first pitch magnet are arranged opposite to each other along a direction parallel to the first axis, and the second pitch sensing element and the second pitch magnet are arranged opposite to each other along a direction parallel to the first axis, and the first pitch sensing element obtains first pitch magnetic field information of the first pitch magnet, and the second pitch sensing element obtains second pitch magnetic field information of the second pitch magnet, so that the stroke of the rotation assembly rotating around the pitch axis can be calculated by the first pitch magnetic field information and the second pitch magnetic field information.

20. A periscope camera module, characterized by comprising:
the reflection module according to claim 1, wherein the reflection module is configured to reflect light incident from a first axis to a second axis, wherein the first axis intersects with the second axis;
a lens module configured to receive the light from the reflection module and continue to propagate the light along a second axis;
a photosensitive module configured to receive light and perform imaging;
a base body having an accommodating cavity, wherein the reflection module and the lens module are arranged in the accommodating cavity, and the base of the reflection module are integrally or separately arranged on the base body; and
a shell which covers on the base body.
